(19) United States
(12) Patent Application Publication
(10) Pub. No.: US 2025/0247900 A1
(43) Pub. Date: Jul. 31, 2025

(54) REGISTRATION OF SERVICE PREFERENCES AND CAPABILITIES

(71) Applicant: QUALCOMM Incorporated, San Diego, CA (US)

(72) Inventors: Rajeev KUMAR, San Diego, CA (US); Aziz GHOLMIEH, Del Mar, CA (US); Miguel GRIOT, La Jolla, CA (US); Gavin Bernard HORN, La Jolla, CA (US)

(21) Appl. No.: 18/429,121

(22) Filed: Jan. 31, 2024

(51) Int. Cl. H04W 76/10; H04L 5/00; H04W 48/16

(52) U.S. Cl. CPC H04W 76/10; H04L 5/0053; H04W 48/16

(57) ABSTRACT

Methods, systems, and devices for wireless communications are described. Techniques described herein may establish a delegation service that may serve as a registry for devices (e.g., user equipments (UEs) or network devices such as operations and management entities (OAMs) and service management and orchestration entities (SMOs)) to register information related to service preferences for one or more network-provided services and a list of services provided by the devices. One or more network entities may access the delegation service and may use the information to determine a service prioritization for each service. The one or more network entities may accordingly configure one or more UEs with one or more services (e.g., network- or UE-provided services) in accordance with the preference information registered in the delegation service and network or operator preference information, as well as the list of services provided by the devices.

### INTRODUCTION

The following relates to wireless communications, including management of service preferences and capabilities.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support registration of service preferences and capabilities.

A method for wireless communications by a UE delegation service is described. The method may include obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services, obtaining a service preference enquiry requesting the list of services provided by the device, the service preference information for the device, or both, and outputting, to the network entity or the one or more other network provided services, the list of services provided by the device, the service preference information for the device, or both.

A UE delegation service for wireless communications is described. The UE delegation service may include one or more memories storing processor executable code, and one or more processors coupled with the one or more memories. The one or more processors may individually or collectively operable to execute the code to cause the UE delegation service to obtain a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services, obtain, from the network entity or the one or more other network provided services, a service preference enquiry requesting the list of services provided by the device, the service preference information for the device, or both, and output, to the network entity or the one or more other network provided services, the list of services provided by the device, the service preference information for the device, or both.

Another UE delegation service for wireless communications is described. The UE delegation service may include means for obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services, means for obtaining, from the network entity or the one or more other network provided services, a service preference enquiry requesting the list of services provided by the device, the service preference information for the device, or both, and means for outputting, to the network entity or the one or more other network provided services, the list of services provided by the device, the service preference information for the device, or both.

A non-transitory computer-readable medium storing code for wireless communications is described. The code may include instructions executable by one or more processors to obtain a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services, obtain, from the network entity or the one or more other network provided services, a service preference enquiry requesting the list of services provided by the device, the service preference information for the device, or both, and output, to the network entity or the one or more other network provided services, the list of services provided by the device, the service preference information for the device, or both.

Some examples of the method, UEs, and non-transitory computer-readable medium described herein may further include operations, features, means, or instructions for obtaining an update to the list of services provided by the device, an update to the service preference information for the device, or both and outputting, to the network entity or the one or more other network provided services, the updated list of services provided by the device, the updated service preference information, or both.

Some examples of the method, UEs, and non-transitory computer-readable medium described herein may further include operations, features, means, or instructions for obtaining a subscription request indicating for the UE delegation service to output, to the network entity or the one or more other network provided services, one or more changes in the list of services provided by the device or the service preference information for the device.

In some examples of the method, UEs, and non-transitory computer-readable medium described herein, the service preference information for the device includes service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Some examples of the method, UEs, and non-transitory computer-readable medium described herein may further include operations, features, means, or instructions for obtaining, from a service consumer, a second service preference enquiry requesting the list of services provided by the device and outputting, to the service consumer, the list of services provided by the device and one or more of an identity of the device, service identifier (ID) information, and service profile information for the list of services provided by the device.

In some examples of the method, UEs, and non-transitory computer-readable medium described herein, the service establishment request message requests to register the device with the UE delegation service and indicates one or more of an ID of the device, service configuration preference information, prioritization information for the list of services provided by the device, measurement gap preferences, radio access technology (RAT) preferences, network type preferences, service instance applicability information that indicates one or more conditions for configuring a service instance, or any combination thereof.

In some examples of the method, UEs, and non-transitory computer-readable medium described herein, the UE delegation service may be implemented at a discovery and selection service (DSS), at the network entity, at a subscription service, or at the one or more other network provided services.

In some examples of the method, UEs, and non-transitory computer-readable medium described herein, the service preference enquiry includes one or more of an ID of the device, one or more service IDs of one or more services, or any combination thereof.

In some examples of the method, UEs, and non-transitory computer-readable medium described herein, the device includes an operations and management (OAM) entity, a service management and orchestration (SMO) entity, or a UE.

A method for wireless communications by a device in a wireless network is described. The method may include transmitting a service establishment request message requesting for the UE delegation service to manage a list of services provided by the device, to manage service preference information for the device, or both, for coordinating with a network entity, one or more other network provided services, or any combination of the network entity and the one or more other network provided services, receiving a service profile configuration that configures the device to provide a first service of the list of services provided by the device or a first network service based on the list of services provided by the device or the service preference information, and communicating service data in accordance with the service profile configuration.

A device in a wireless network for wireless communications is described. The device in a wireless network may include one or more memories storing processor executable code, and one or more processors coupled with the one or more memories. The one or more processors may individually or collectively operable to execute the code to cause the device in a wireless network to transmit a service establishment request message that requests for the UE delegation service to manage a list of services provided by the device, to manage service preference information for the device, or both, for coordinating with a network entity, one or more other network provided services, or any combination of the network entity and the one or more other network provided services, receive a service profile configuration that configures the device to provide a first service of the list of services provided by the device or a first network service based on the list of services provided by the device or the service preference information, and communicate service data in accordance with the service profile configuration.

Another device in a wireless network for wireless communications is described. The device in a wireless network may include means for transmitting a service establishment request message that requests for the UE delegation service to manage a list of services provided by the device, to manage service preference information for the device, or both, for coordinating with a network entity, one or more other network provided services, or any combination of the network entity and the one or more other network provided services, means for receiving a service profile configuration that configures the device to provide a first service of the list of services provided by the device or a first network service based on the list of services provided by the device or the service preference information, and means for communicating service data in accordance with the service profile configuration.

A non-transitory computer-readable medium storing code for wireless communications is described. The code may include instructions executable by one or more processors to transmit a service establishment request message requesting for the UE delegation service to manage a list of services provided by the device, to manage service preference information for the device, or both, for coordinating with a network entity, one or more other network provided services, or any combination of the network entity and the one or more other network provided services, receive a service profile configuration that configures the device to provide a first service of the list of services provided by the device or a first network service based on the list of services provided by the device or the service preference information, and communicate service data in accordance with the service profile configuration.

Some examples of the method, devices in a wireless network, and non-transitory computer-readable medium described herein may further include operations, features, means, or instructions for transmitting, to the UE delegation service, an update to the list of services provided by the device, an update to the service preference information for the device, or both based on a change in the list of services provided by the device, a change in the service preference information for the device, a change in geographical location of the device, or any combination thereof.

In some examples of the method, devices in a wireless network, and non-transitory computer-readable medium described herein, the service preference information for the device includes service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

In some examples of the method, devices in a wireless network, and non-transitory computer-readable medium described herein, the service profile configuration includes a service ID, service prioritization information, a periodicity associated with reporting information related to one or more services, an indication of one or more triggers for reporting the information related to one or more services, or any combination thereof.

Some examples of the method, devices in a wireless network, and non-transitory computer-readable medium described herein may further include operations, features, means, or instructions for receiving an indication of service preference information for one or more other devices of the wireless network.

In some examples of the method, devices in a wireless network, and non-transitory computer-readable medium described herein, the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

Some examples of the method, devices in a wireless network, and non-transitory computer-readable medium described herein may further include operations, features, means, or instructions for transmitting, to the network entity or the one or more other network provided services, an acknowledgement message in response to the service profile configuration.

In some examples of the method, devices in a wireless network, and non-transitory computer-readable medium described herein, the device includes an OAM entity, a SMO entity, or a UE.

A method for wireless communications by a network entity is described. The method may include outputting a service preference enquiry requesting a list of services provided by a device in a wireless network, service preference information for the device, or both, obtaining the list of services provided by the device, the service preference information for the device, or both, and outputting, to the device, a service profile configuration that indicates a first service of the list of services provided by the device or a first network service based on the list of services provided by the device or the service preference information.

A network entity for wireless communications is described. The network entity may include one or more memories storing processor executable code, and one or more processors coupled with the one or more memories. The one or more processors may individually or collectively operable to execute the code to cause the network entity to output a service preference enquiry that requests a list of services provided by a device in a wireless network, service preference information for the device, or both, obtain the list of services provided by the device, the service preference information for the device, or both, and output, to the device, a service profile configuration that indicates a first service of the list of services provided by the device or a first network service based on the list of services provided by the device or the service preference information.

Another network entity for wireless communications is described. The network entity may include means for outputting a service preference enquiry requesting a list of services provided by a device in a wireless network, service preference information for the device, or both, means for obtaining the list of services provided by the device, the service preference information for the device, or both, and means for outputting, to the device, a service profile configuration that indicates a first service of the list of services provided by the device or a first network service based on the list of services provided by the device or the service preference information.

A non-transitory computer-readable medium storing code for wireless communications is described. The code may include instructions executable by one or more processors to output a service preference enquiry that requests a list of services provided by a device in a wireless network, service preference information for the device, or both, obtain the list of services provided by the device, the service preference information for the device, or both, and output, to the device, a service profile configuration that indicates a first service of the list of services provided by the device or a first network service based on the list of services provided by the device or the service preference information.

In some examples of the method, network entities, and non-transitory computer-readable medium described herein, the service preference enquiry includes one or more of an ID of the device, one or more service IDs of one or more services, or any combination thereof.

Some examples of the method, network entities, and non-transitory computer-readable medium described herein may further include operations, features, means, or instructions for outputting a subscription request indicating for the UE delegation service to output, to the network entity, one or more changes in the list of services provided by the device or the service preference information for the device.

In some examples of the method, network entities, and non-transitory computer-readable medium described herein, the service preference information for the device includes service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

In some examples of the method, network entities, and non-transitory computer-readable medium described herein, the service profile configuration includes a service ID, service prioritization information, a periodicity associated with reporting information related to one or more services, an indication of one or more triggers for reporting the information related to one or more services, or any combination thereof.

Some examples of the method, network entities, and non-transitory computer-readable medium described herein may further include operations, features, means, or instructions for obtaining, from a second network entity, an ID of the device and a selection service ID that identifies the network entity as being a selection service for the device, selecting one or more services for the device based on the ID of the device and the selection service ID, and outputting, to the second network entity, an indication of one or more service IDs of the one or more services, one or more supported functions of the one or more services, routing information associated with the one or more services, or any combination thereof.

Some examples of the method, network entities, and non-transitory computer-readable medium described herein may further include operations, features, means, or instructions for outputting, to a DSS, an ID of the device and a selection service ID that identifies the DSS as being a selection service for the device and obtaining, from the DSS, an indication of one or more service IDs of one or more services selected for the device, one or more supported functions of the one or more services, routing information associated with the one or more services, or any combination thereof.

Some examples of the method, network entities, and non-transitory computer-readable medium described herein may further include operations, features, means, or instructions for outputting, to the device, an indication of service preference information for one or more additional devices in the wireless network.

Some examples of the method, network entities, and non-transitory computer-readable medium described herein may further include operations, features, means, or instructions for obtaining, from the device, an acknowledgement message in response to the service profile configuration.

In some examples of the method, network entities, and non-transitory computer-readable medium described herein, the network entity includes a DSS, a radio access network (RAN) entity, an access and mobility service, a topology management service, a subscription service, or one or more other network provided services.

In some examples of the method, network entities, and non-transitory computer-readable medium described herein, the device includes an OAM entity, a SMO entity, or a UE.

### BRIEF DESCRIPTION OF THE DRAWINGS

FIG. 1 shows an example of a wireless communications system that supports registration of service preferences and capabilities in accordance with one or more aspects of the present disclosure.

FIG. 2 shows an example of a network architecture that supports registration of service preferences and capabilities in accordance with one or more aspects of the present disclosure.

FIG. 3 shows an example of a wireless communications system that supports registration of service preferences and capabilities in accordance with one or more aspects of the present disclosure.

FIG. 4 shows an example of a process flow that supports registration of service preferences and capabilities in accordance with one or more aspects of the present disclosure.

FIG. 5 shows an example of a process flow that supports registration of service preferences and capabilities in accordance with one or more aspects of the present disclosure.

FIG. 6 shows an example of a process flow that supports registration of service preferences and capabilities in accordance with one or more aspects of the present disclosure.

FIG. 7 shows an example of a process flow that supports registration of service preferences and capabilities in accordance with one or more aspects of the present disclosure.

FIG. 8 shows an example of a process flow that supports registration of service preferences and capabilities in accordance with one or more aspects of the present disclosure.

FIG. 9 shows an example of a process flow that supports registration of service preferences and capabilities in accordance with one or more aspects of the present disclosure.

FIG. 10 shows an example of a wireless communications system that supports registration of service preferences and capabilities in accordance with one or more aspects of the present disclosure.

FIGS. 11 and 12 show block diagrams of devices (e.g., network entities and delegation services) that support registration of service preferences and capabilities in accordance with one or more aspects of the present disclosure.

FIG. 13 shows a block diagram of a communications manager that supports registration of service preferences and capabilities in accordance with one or more aspects of the present disclosure.

FIG. 14 shows a diagram of a system including a device that supports registration of service preferences and capabilities in accordance with one or more aspects of the present disclosure.

FIGS. 15 and 16 show block diagrams of devices that support registration of service preferences and capabilities in accordance with one or more aspects of the present disclosure.

FIG. 17 shows a block diagram of a communications manager that supports registration of service preferences and capabilities in accordance with one or more aspects of the present disclosure.

FIG. 18 shows a diagram of a system including a device that supports registration of service preferences and capabilities in accordance with one or more aspects of the present disclosure.

FIGS. 19 through 22 show flowcharts illustrating methods that support registration of service preferences and capabilities in accordance with one or more aspects of the present disclosure.

### DETAILED DESCRIPTION

In some wireless communication systems, a UE may provide one or more services to a network or may use one or more services provided by the network. As described herein, a service may be hosted at one or more components of a cloud-based network, where the components of each service may be associated with a respective network address. The respective one or more services may be provided by network providers, network entities, UEs, third-party entities, etc., where each service is configured to support a respective service or functionality offered to the UE, the network entity, and so on. In some examples, a network entity (e.g., a RAN node, a DSS, an access and mobility service (AMS), topology management service, subscription services, and so on) may select one or more services to configure a UE to provide or to perform. For example, a DSS may be a service to discover one or more services that may be provided to the UE (e.g., based on geographic location, network traffic, and so on) and may select one or more services for the UE to use.

Different services, functionalities, and functions that may be supported or offered by one or more services (e.g., network-provided services or UE-provided services) may include, but are not limited to, a mobility service, a security service, a privacy service, a location service, delegation service, etc. In some implementations, a service may be a network-provided service provided by a network entity such as a RAN node or one or more other entities, such as a DSS, an AMS, topology management service, subscription services, and so on. In some implementations, a service may be a UE-provided service (e.g., provided to one or more network entities), such as RAN or 6G services, federated model training, end-to-end health recommendation services (e.g., sensing health data in an area and provide sensed health data to a healthcare provides such that healthcare providers may provide health recommendations to users), end-to-end security recommendation services (e.g., providing crime or accident footage or sensing data to police), traffic conditions, or one or more other services related to sensors of the UE.

In some examples, the UE may have information related to UE preferences or priorities for services used by the UE (e.g., configuration preferences, measurement gap preferences, and so on). In some examples, the UE may have a one or more services (e.g., a list or class of one or more services) that the UE has the capability to perform. However, in some examples, one or more network entities (e.g., a network operator, RAN node, a DSS entity, or one or more other network-provided services) may select one or more network- or UE-provided services to configure for the UE. Such network entities may make service selections without accounting for the UE, RAN, and operator preferences without such UE preference or information related to the class of services provided by the UE. For example, a RAN node may determine to configure the UE to perform a service related to providing crime or accident footage. However, the UE may have a processing or power consumption restriction, and may have one or more other operations to perform within the restriction. That is, the UE may have a preference to perform one or more other operations (e.g., rather than providing the crime or accident footage) due to the resurrection, and the RAN node may configure the UE to perform the service if the RAN node is not aware of the preference.

Accordingly, techniques described herein may establish a delegation service (e.g., a UE delegation service) that may serve as a registry for devices (UEs or network devices such as OAMs and SMOs) to register information related to service preferences for one or more network-provided services and a list of services provided by the devices. That is, the UEs and/or network devices may transmit the service preferences and the list of one or more services that the UE has a capability to provide to the delegation services, and one or more network entities (e.g., a RAN node, a DSS) may request to receive the service information from the registry. As described herein, an OAM may be an entity that coordinates management and upkeep of a network (e.g., via fault management, performance management, configuration management, and so on). An SMO may be an entity that may facilitate management of services (e.g., by creating, terminating, and delivering services). The SMO may perform such operations to increase a quality of service (QOS) of one or more services.

One or more network entities (a RAN node, a DSS, etc.) may receive the service preference information from the delegation service and may use the information to determine a service prioritization for each service. The one or more network entities (e.g., the RAN node, the DSS) may accordingly configure one or more UEs with one or more services (e.g., network- or UE-provided services) in accordance with the preference information registered in the delegation service, as well as the list of services provided by the devices. In some examples, a separate registry may be established for UEs and for other network devices (e.g., the OAM, the SMO). In some examples, the devices may update the registry, and the one or more network entities may access the updated registry or subscribe to receive updates from the delegation service.

Such techniques may provide for improved coordination between devices related to multiple devices of a network (e.g., a RAN node, a DSS, a UE, an OAM, an SMO) accessing preferences of other devices and other information related to services in the network. The described techniques may result in improved utilization of processing capability resulting, improved communication reliability, improved user experience related to reduced processing, and reduced power consumption from accounting for UE, network, and operator (e.g., OAM, SMO) preferences in configuring services. For example, the network entity may reduce processing at the UE by accounting for UE preferences (e.g., processing-related preferences) in configuring one or more services.

Aspects of the disclosure are initially described in the context of wireless communications systems and network architectures. Aspects of the disclosure are further illustrated by and described with reference to process flow diagrams, apparatus diagrams, system diagrams, and flowcharts that relate to registration of service preferences and capabilities.

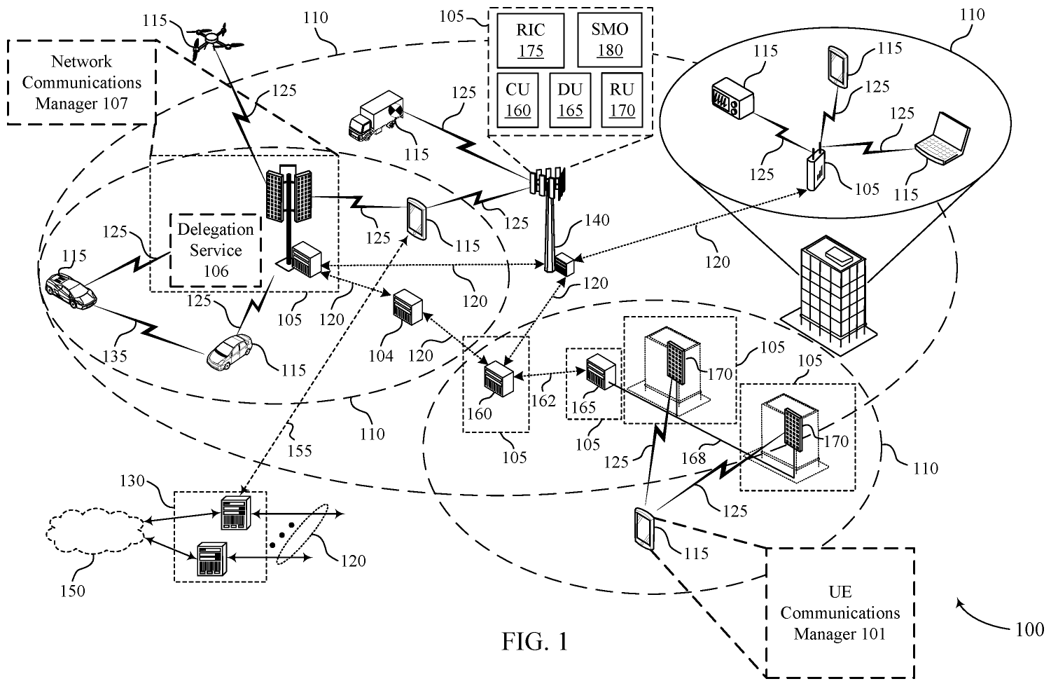

FIG. 1 shows an example of a wireless communications system 100 that supports registration of service preferences and capabilities in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

In some examples, one or more UEs 115 and network entities 105 may communicate via UE communications managers 101 and network communications managers 107. For example, a UE 115 may include a UE communications manager 101, which may be an example of communications managers as described herein. The UE 115 may, via the UE communications manager 101, register a list of services provided by the UE 115 and/or service preference information for the UE 115. A network entity 105 may include a network communications manager 107, which may be an example of communication managers as described herein. The network entity 105 may, via the network communications manager 107, receive the list of services and/or the service preference information (e.g., from the UE 115 or from another entity, such as a delegation service 106). The network entity 105 may configure the UE 115 with one or more services based on the service information via the network communications manager 107.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, the wireless communications system 100 may include a delegation service 106 (e.g., a UE delegation service) that may perform one or more operations to facilitate registration of service preferences and capabilities for entities in the wireless communications system 100. For example, the delegation service 106 may include a communications manager (e.g., a network communications manager 107) that may allow the delegation service 106 to manage a list of services provided by a UE 115 and one or more service preferences of the UE 115 or one or more other entities (e.g., network entities 105) in the wireless communications system 100. In some examples, the delegation service 106 may co-located with one or more other network entities 105 (e.g., RAN nodes, other network-provided services) as illustrated with reference to FIG. 1. In some examples, the delegation service 106 may be a separate entity in the wireless communications system 100.

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a SMO 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support registration of service preferences and capabilities as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (RAT) (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported DFT size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a delegation service (e.g., a UE delegation service) may serve as a registry for devices (UEs 115 or network devices such as OAMs and SMOs) to register information related to service preferences for one or more network-provided services and a list of services provided by the devices. One or more network entities 105 (a RAN node, a DSS, etc.) may access the delegation service and may use the information to determine a service prioritization for each service. The one or more entities 105 may accordingly configure one or more UEs 115 with one or more services (e.g., network or UE provided services) in accordance with the preference information registered in the delegation service, as well as the list of services provided by the devices. In some examples, a separate registry may be established for UEs 115 and for other network devices (e.g., the OAM, the SMO). In some examples, the devices may update the registry, and the one or more network entities 105 may access the updated registry or subscribe to receive updates from the delegation service.

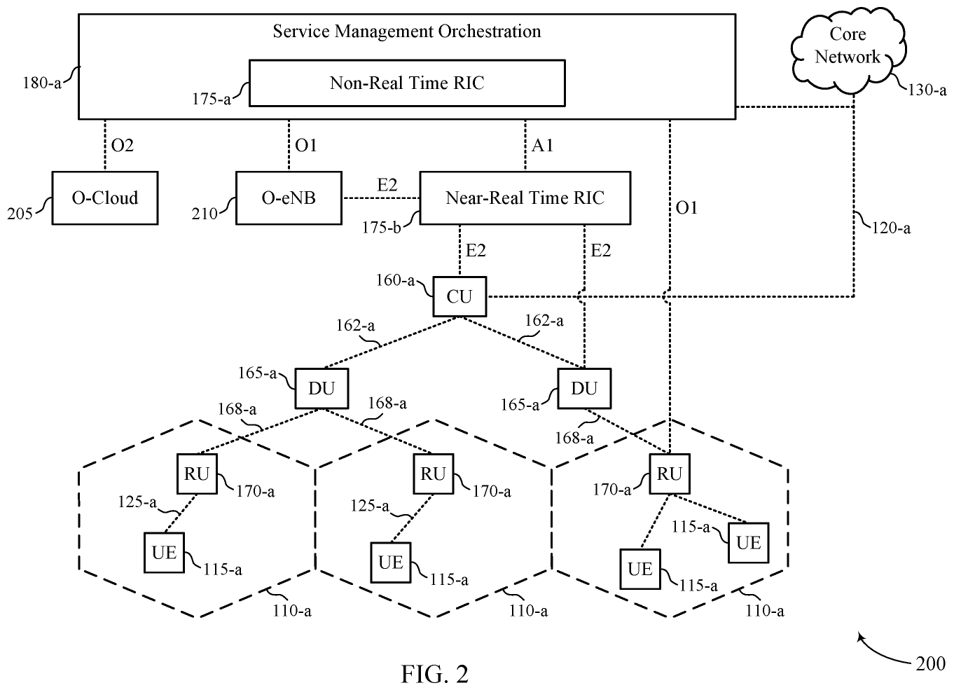

FIG. 2 shows an example of a network architecture 200 (e.g., a disaggregated base station architecture, a disaggregated RAN architecture) that supports registration of service preferences and capabilities in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

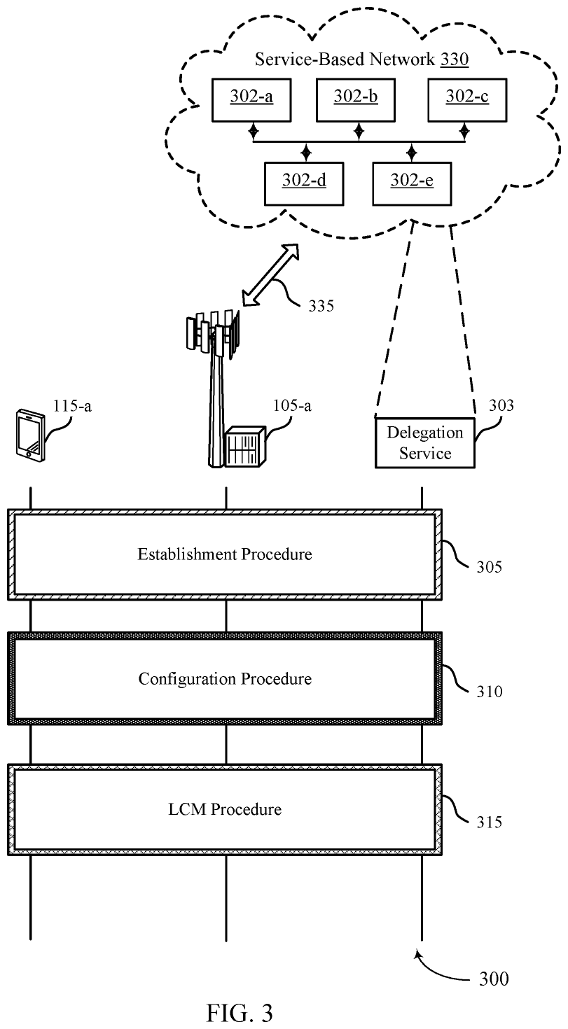

FIG. 3 shows an example of a wireless communications system 300 that supports registration of service preferences and capabilities in accordance with one or more aspects of the present disclosure. The wireless communications system 300 may implement or may be implemented by aspects of the wireless communications system 100 or the network architecture 200. For example, the wireless communications system 300 may include a UE 115 (e.g., a UE 115-a) and a network entity 105 (e.g., a network entity 105-a), which may be examples of the corresponding devices as described with reference to FIG. 1. In some cases, the UE 115-a may refer to one or more UEs 115. In some implementations, the network entity 105-a may refer to one or more network entities 105. In some implementations, the network entity 105-a may refer to a RAN of one or more network entities 105 or a DSS of the wireless communications system 300. For brevity, the network entity 105-a is discussed, but a RAN may also be used in its place.

The wireless communications system 300 also includes a service-based network 330. In some examples, the network entity 105-a may be configured to connect the UE 115-a to one or more services 302 (e.g., network services) of the service-based network 330. In particular, the network entity 105-a may be configured to relay communications between the UE 115-a and the one or more various services 302 of the service-based network 330 via one or more communication links 335 to enable the UE 115-a to establish and maintain wireless connections with the respective one or more services 302 in order to exchange communications associated with the various functionalities that are supported by the respective one or more services 302. In other words, the wireless communications system 300 may enable the UE 115-a or the network entity 105-a to “subscribe” to the respective one or more services 302 on an à la carte basis depending on the needs of the UE 115-a and the network entity 105-a. In this regard, different UEs 115 within the wireless communications system 300 may be able to subscribe to different subsets of one or more services 302 depending on the capabilities of the UEs 115, applications executed at the UEs 115, a mobility of the UEs 115, etc.

Each service 302 may be associated with a respective network address within the service-based network 330. Stated differently, each service 302 may be hosted at one or more components of a cloud-based network, where the components of each service 302 may be associated with a respective network address. The respective one or more services 302 may be provided by network providers, network entities 105, UEs 115, third-party entities, etc., where each service 302 is configured to support a respective service or functionality offered to the components of the wireless communications system 300 (e.g., the UE 115-a, the network entity 105-a).

Different services, functionalities, and functions that may be supported or offered by the respective services 302-a through 302-e may include, but are not limited to, a mobility service, a security service, a privacy service, a location service, etc. In other words, the service 302 may refer to any of one or more services (e.g., 302-a, 302-b, 302-c, 302-d, or 302-e) provided to or provided by the UE 115-a, the network entity 105-a, or both. In some implementations, the service 302 may be a network provided service. In some implementations, the service 302 may be a delegation service 303 (e.g., a UE delegation service 303). Therefore, the UE delegation service 303 may be a part of the service-based network 315. In some other examples, the UE delegation service 303 may be separate from the service-based network 330 and the UE delegation service may communicate with the service-based network 315. In some implementations, the service 302 may be a UE-provided service 302, such as RAN or 6G services, federated model training, end-to-end health recommendation services (e.g., sensing health data in an area and provide sensed health data to a healthcare provides such that healthcare providers may provide health recommendations to users), end-to-end security recommendation services (e.g., providing crime or accident footage or sensing data to police), traffic conditions, or one or more other services related to sensors of the UE 115-a.

In some examples, the UE 115-a (e.g., and one or more other devices in the wireless communications system 300) may have one or more services 302 provided by the UE 115-a (e.g., a list of services) and one or more preferences regarding one or more network services used by the UE 115-a (e.g., or an OAM, SMO, etc.). For example, the UE 115-a, the OAM, or the SMO may have preferences for different functions or services based on UE configuration, UE status, region (e.g., geographical area), RAN configurations, and so on. Such preferences may be preferences within a service or across one or more services. In some examples, the UE 115-a may have a class (e.g., a list) of services in which the UE 115-a may participate (e.g., provide). Such UE-provided services may be RAN or service initiated. Accordingly, the network entity 105-a (e.g., or one or more other entities in the wireless communications system 300) may use service preference information and the list of services in which the UE 115-a may participate to configure one or more services for the UE 115-a.

Accordingly, as described herein, a delegation service 303 (e.g., a UE delegation service) may manage the service preference information and the list of services provided by the UE 115-a. That is, via a service establishment procedure, the delegation service 303 may receive the list of services provided by the UE 115-a and the service preference information for one or more network-provided services (e.g., from the UE 115-a, the OAM, and/or the SMO) via a service establishment procedure 305. One or more network entities 105 (e.g., a RAN, a DSS) may access the delegation service and may configure one or more services or service preference to the UE 115-a via a configuration procedure 310.

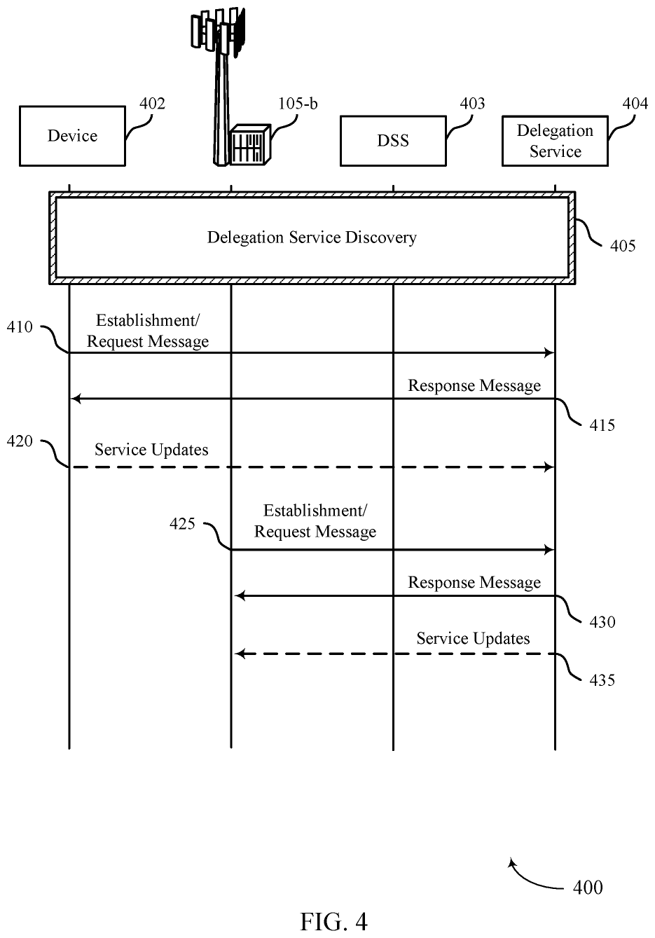

In some examples, the UE 115-a (e.g., or one or more other devices in a wireless network) may discover an available service 302 in the service establishment procedure 305. Additionally, or alternatively, UE 115-a may establish a connection with the service 302 during the service establishment procedure 305. In some examples, the service establishment procedure 305 may include a capability exchange. The service establishment procedure is further discussed with reference to FIG. 4.

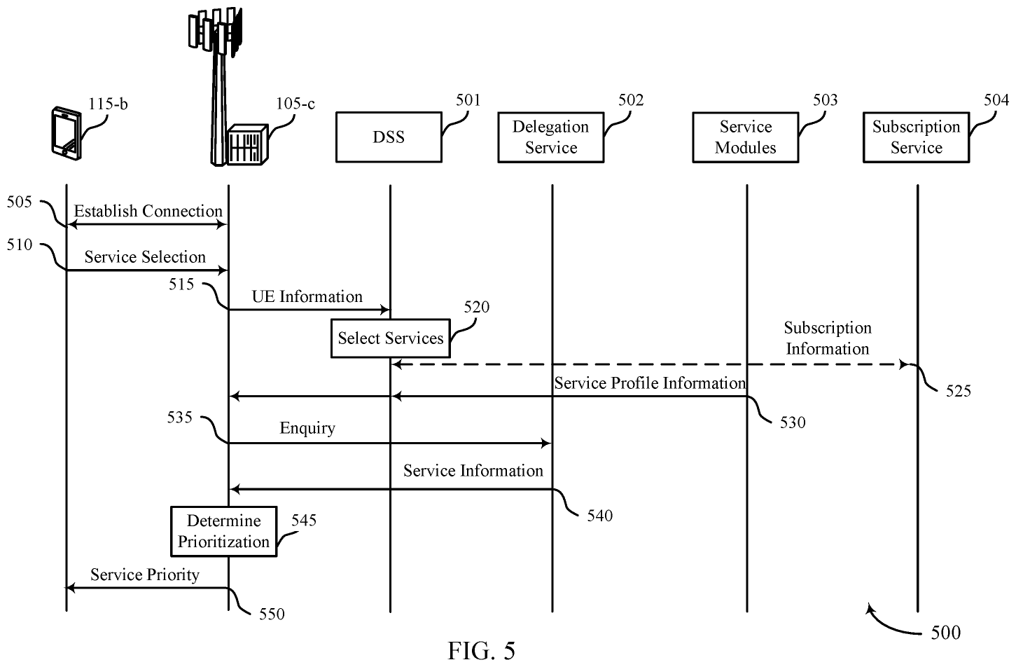

In some implementations, the service 302 may transmit configuration signaling to the UE 115-a during the configuration procedure 310. In some examples, the service 302 may configure the UE 115-a and the network entity 105-a (e.g., to perform the configuration procedure). Additionally, or alternatively, the network entity 105-a may provide additional configuration signaling to the UE 115-a, the service 302, or both. For example, the network entity 105-a may provide lower layer configuration signaling. In some cases, the network entity 105-a may configure an interface for the UE 115-a (e.g., an air interface, Uu link, access link, etc.). For example, the network entity 105-a may transmit an indication of a configuration of the interface for the UE 115-a to perform the configuration procedure 310. The configuration procedure 310 is further discussed with reference to FIGS. 5-8.

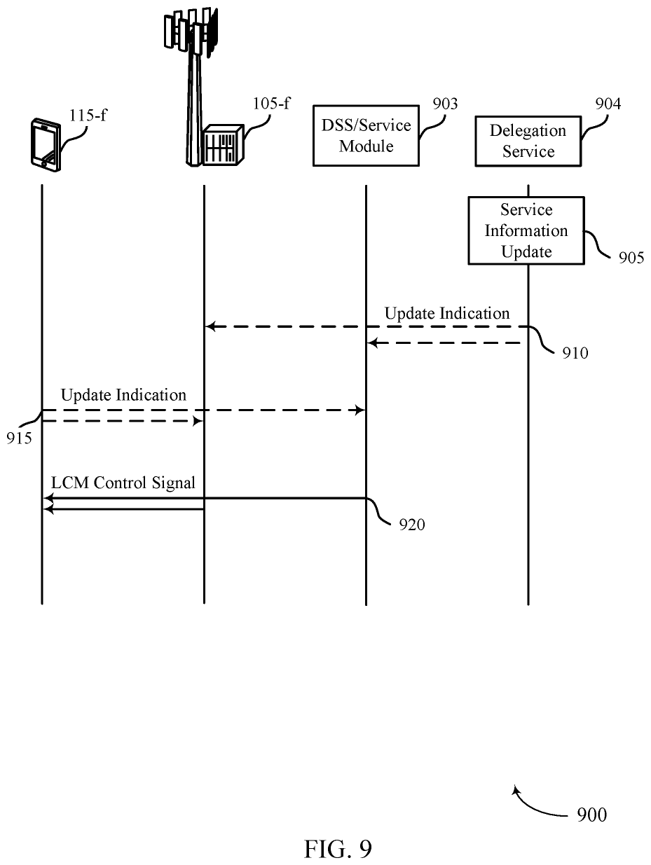

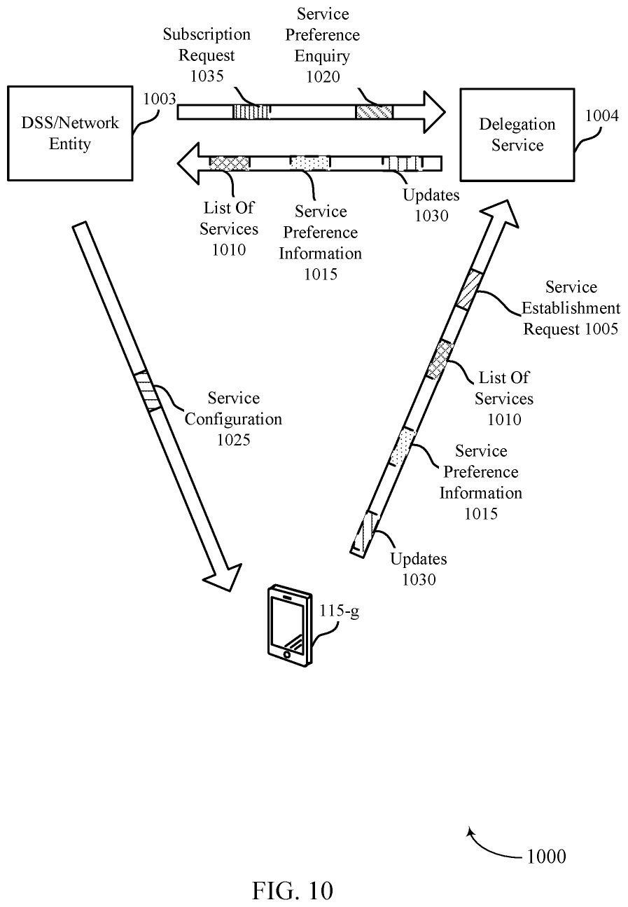

In some examples, the UE 115-a, network entity 105-a, service 302, or any combination thereof may monitor input signaling during life cycle management (LCM) procedure(s) 315. In some examples, the LCM procedure may be based on the output of the monitoring by the UE 115-a, network entity 105-a, service 302, or any combination thereof. In some examples, the LCM procedure(s) may include activate, deactivate, fallback, switch, or reconfigure procedures. The monitoring and LCM procedure(s) 315 are further discussed with reference to FIGS. 9-10.

FIG. 4 shows an example of a process flow 400 that supports registration of service preferences and capabilities in accordance with one or more aspects of the present disclosure. The process flow 400 may implement or may be implemented by aspects of the wireless communications system 100, the network architecture 200, or the wireless communications system 300. For example, the process flow 400 may be implemented by a UE 115 and a network entity 105 (e.g., a network entity 105-b), which may be examples of the corresponding devices as described with reference to FIG. 1. The process flow 400 may include a device 402 (e.g., a device in a wireless communications system), which may be an example of a UE 115, an OAM, or a SMO. While the operations of the process flow 400 are described with reference to a DSS 403, the process flow 400 may also be used by one or more other network provided services (e.g., an AMS, topology management service, subscription service).

In the following description of the process flow 400, the operation between the device 402, the network entity 105-b, the DSS 403, and the delegation service 404 may be transmitted in a different order shown. Some operations may also be omitted from the process flow 400, and other operations may be added to the process flow 400. Further, although some operations or signaling may be shown to occur at different times for discussion purposes, these operations may occur at the same time.

In some examples, the delegation service 404 may be implemented at (e.g., co-located with) the network entity 105-b (e.g., a RAN node), the DSS 403, a subscription service, the OAM, the SMO, or one or more other services. In such examples, the operations or signaling shown between the devices of the process flow 400 may be between different devices than illustrated. For example, if the delegation service 404 is implemented at the network entity 105-b, the device 402 may transmit a service establishment request message to the network entity 105-b. In some examples, the delegation service 404 may be a separate network service (e.g., not co-located with one or more other services or entities), as illustrated with reference to the process flow 400.

In some examples, the delegation service 404 may be more than one entity. For example, the delegation service 404 may be a first delegation service for UE 115 service preference and/or UE-provided service information, and a second delegation service for network (e.g., network operator, OAM, SMO) service preference information. In such examples, the network entity 105-b (e.g., and the DSS 403 or one or more other network-provided service entities) may communicate service establishment messages, subscription requests, service information, and so on with both of the first delegation service and the second delegation service.

At 405, the device 402, the network entity 105-b, and the DSS 403 may discover the delegation service 404 (e.g., a UE delegation service). For example, the device 402, the network entity 105-b, and the DSS 403 may identify a delegation service ID and routing information associated with the delegation service 404. In some examples, the delegation service may advertise for the device 402 to register one or more service preferences of the device or a list of services provided by the device 402 (e.g., UE-provided services) with the delegation service 404.

At 410, the device 402 may transmit, to the delegation service 404, a service establishment request message requesting for the delegation service 404 to manage service preference information and/or a list of services provided by the device 402 (e.g., UE-provided services). That is, the service establishment request message may include a request to register the device 402 with the delegation service 404. At 415, the device 402 may receive a response message from the delegation service 404. The delegation service 404 may manage the list of services provided by the device and the service preference information for coordinating with the network entity 105-b or the DSS 403 (e.g., or the one or more other network-provided services).

In some examples, the service establishment request message (e.g., or one or more additional messages) may indicate the service preference information, the list of one or more services provided by the device 402, and/or a UE ID (e.g., an identity associated with the device 402 or associated with another UE 115 for which the service preference information is applicable). The service preference information may include, for example, one or more of a prioritization of one or more network-provided services to be used by the device 402, a prioritization of one or more services provided by the device 402, a preferred configuration for the one or more network-provided services, measurement gap preferences, RAT preferences, network type preferences, or service instance applicability information (e.g., indicating one or more conditions for configuring a particular service instance used by or provided by the device 402). In some examples, the service instance applicability information may include applicability for ML- or AI-related services.

In some examples, if the device 402 is a UE 115, a granularity of the service preference information may be for each feature (e.g., services including AI or ML features) supported by the device 402, for one or more feature groups (e.g., groups of services, including AI or ML feature groups) supported by the device 402, or for one or more functionalities (e.g., functions that may be performed by a UE 115 or network entity related to services, including AI or ML functionalities) supported by the device 402. In some examples, the granularity of the service preference information may be for each configuration, such as for one or more codebook indexes used by the network entity 105-b, for one or more antenna patterns used by the network entity 105-b for communication with device 402, for one or more beams (e.g., a synchronization signal block (SSB) beam or CSI-RS beam associated with a beam index) used by the device 402 or by the network entity 105-b, for one or more operating modes used by the network entity 105-b (e.g., energy saving mode, non-energy saving mode), and/or for one or more geographical areas (e.g., per RAN notification area, target area, Public Land Mobile Network (PLMN), etc.). In some examples, if the device 402 is an OAM or an SMO, a granularity of the service preference information may be UE-specific (e.g., for each UE 115 in a wireless communications system) or non-UE specific (e.g., applying to services used by each UE 115 in the wireless communications system).

In some examples, at 420, the device 402 may transmit one or more updates to the list of services provided by the device 402 or to the service preference information. For example, the device 402 may update the list of services provided by the device 402 or to the service preference information if the device 402 moves out of a service area, if the device 402 no longer supports one or more services of the list of services provided by the device 402 (e.g., due to low power status, computation resource status, and so on), or if the device 402 identifies one or more changes to the service preference information.

At 425, the network entity 105-b (e.g., or the DSS 403) may transmit a service establishment request message to the delegation service 404. The service establishment request message may include a service preference enquiry requesting the list of services provided by the device 402, the service preference information, or both. In some examples, the service establishment request message (e.g., or another message from the network entity 105-b or the DSS 403) may include a subscription request indicating for the delegation service 404 to output, to the network entity 105-b or the DSS 403, one or more changes in the list of services provided by the device 402 or the service preference information.

At 430, the delegation service 404 may transmit a response message to the network entity 105-b (e.g., or the DSS 403). For example, the delegation service 404 may output, to the network entity 105-b or the DSS 403, the requested list of services provided by the device 402 and/or the requested service preference information.

In some examples, at 435, the delegation service 404 may transmit one or more service updates to the network entity 105-b or the DSS 403. For example, the delegation service 404 may output the updated list of services provided by the device 402 and/or the updated service preference information (e.g., in response to the subscription request or another request for the service preference updates).

FIG. 5 shows an example of a process flow 500 that supports registration of service preferences and capabilities in accordance with one or more aspects of the present disclosure. The process flow 500 may implement or may be implemented by aspects of the wireless communications system 100, the network architecture 200, the wireless communications system 300, or the process flow 400. For example, the process flow 500 may include a UE 115 (e.g., a UE 115-b) and a network entity 105 (e.g., a network entity 105-c), which may be examples of the corresponding devices as described with reference to FIG. 1. While the operations of the process flow 500 are described with reference to a DSS 501, the process flow 500 may also be used by one or more other network provided services (e.g., an AMS, topology management service, subscription services).

In the following description of the process flow 500, the operation between the UE 115-b, the network entity 105-c, the DSS 501, the delegation service 502, the service modules 503, and the subscription service 504 may be transmitted in a different order shown. Some operations may also be omitted from the process flow 500, and other operations may be added to the process flow 500. Further, although some operations or signaling may be shown to occur at different times for discussion purposes, these operations may occur at the same time.

In some examples, the delegation service 502 may be implemented at (e.g., co-located with) the network entity 105-c (e.g., a RAN node), the DSS 501, the subscription service 504, the OAM, the SMO, or one or more other services (e.g., the service modules 503). In such examples, the operations or signaling shown between the devices of the process flow 500 may be between different devices than illustrated. For example, if the delegation service 502 is implemented at the subscription service 504, the network entity 105-c may transmit a service preference enquiry to the subscription service 504. In some examples, the delegation service 502 may be a separate network service (e.g., not co-located with one or more other services or entities), as illustrated with reference to the process flow 500.

In some examples, the delegation service 502 may be more than one entity. For example, the delegation service 502 may be a first delegation service for UE 115 service preference and/or UE-provided service information, and a second delegation service for network (e.g., network operator, OAM, SMO) service preference information. In such examples, the network entity 105-c (e.g., and the DSS 501 or one or more other network-provided service entities) may communicate service establishment messages, service enquiry messages, subscription requests, service information, and so on with both of the first delegation service and the second delegation service.

At 505, the UE 115-b may establish a connection with the network entity 105-c (e.g., a RAN node). For example, the UE 115-b may determine if access stratum (AS) and non-AS (NAS) security is active. At 510, the UE 115-b may transmit, to the network entity 105-c, an AS transport message indicating a service selection ID (e.g., identifying the DSS 501 as being a selection service for the UE 115-b and requesting for the network entity 105-c to provide one or more service IDs). In some examples, the AS transport message or one or more other messages may indicate an ID of the UE 115-b.

At 515, the network entity 105-c may transmit the selection service ID and UE information (e.g., including the ID of the UE 115-b) to the DSS 501. In some examples, the network entity 105-c may also transmit one or more service preferences (e.g., RAN service preferences) to the DSS 501 for facilitating service selection.

At 520, the DSS 501 may select one or more services (e.g., one or more services associated with the service selection ID). In some examples (e.g., if the delegation service is implemented at or co-located with the DSS 501), the DSS 501 may consider available preferences of the UE 115-b, the network entity 105-c, a network operator (e.g., an OAM or SMO), and so on to select the services. In some examples, the DSS 501 may perform selection of one or more UEs 115 to configure with UE-provided services based on the list of services provided by the UE 115-b (e.g., and one or more other lists of services provided by UEs 115).

At 525, the DSS 501 may transmit, to the subscription service 504, a request to check subscription information related to the selected services (e.g., UE 115-b subscription information). The subscription service 504 may provide the subscription information for the selected services in response to the request to the DSS 501.

At 530, DSS 501 may retrieve (e.g., receive, obtain), from the service modules 503, service profile information for the selected services. For example, the DSS 501 may transmit a service profile enquiry to the service modules 503 and may receive the service profile information in response to the enquiry. The DSS 501 may output, to the network entity 105-c, the service profile information (e.g., service IDs, one or more functionalities supported by the UE 115-b, routing information, and so on).

At 535, the network entity 105-c may output, to the delegation service 502, a service preference enquiry requesting a list of service provided by the UE 115-b, service preference information for the UE 115-b (e.g., and/or for a network operator, OAM, SMO), or both. In some examples, the service preference enquiry (e.g., or a separate message) may include a subscription to changes in the list of services or the service preference information (e.g., a flag indicating for the delegation service 502 to provide updates to the list of services and the service preference information).

At 540, the network entity 105-c may retrieve (e.g., receive, obtain) the list of services provided by the UE 115-b, service preference information for the UE 115-b (e.g., and/or for a network operator, OAM, SMO), or both from the delegation service 502 in response to the service preference enquiry. In some examples, the network entity 105-c may obtain one or more updates to the list of services or the service preference information (e.g., in response to the subscription).

At 545, the network entity 105-c may determine a prioritization for configuring the UE 115-b with one or more services (e.g., UE-provided or network-provided services) or functionalities. For example, the network entity 105-c may consider the list of services provided by the UE 115-b and/or the service preference information of the UE 115-b, the network entity 105-c, a network operator (e.g., an OAM or SMO), and so on to determine an overall service or function prioritization.

At 550, the network entity 105-c may transmit (e.g., output) a service profile configuration or service priority information indicating a service profile of a first service of the list of services provided by the UE 115-b, a first network service, and so on based on determining the prioritization. That is, the network entity 105-c may configure the UE 115-b with one or more UE- or network-provided services (e.g., may configure the UE 115-b to provide a first service of the list of services provided by the device or with a first network service). In some examples, the service priority information or the service profile configuration may include one or more service IDs, supported functionalities, service or functionality prioritization information, routing information, and so on. The UE 115-b may communicate service data with the network entity 105-c in accordance with the configuration. For example, the UE 115-b may use or provide one or more services in accordance with the configuration.

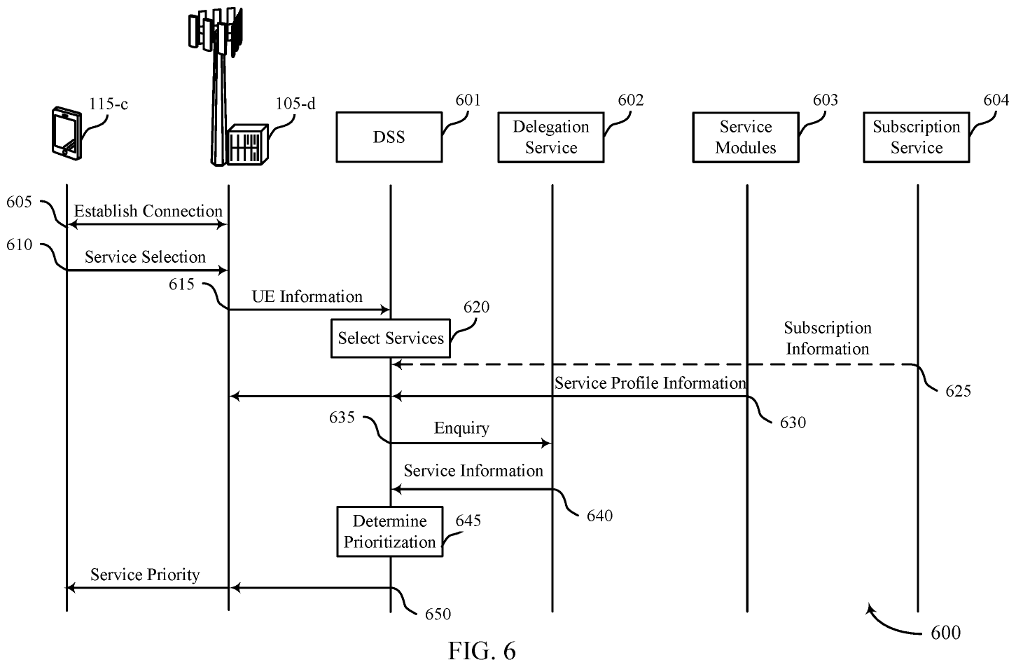

FIG. 6 shows an example of a process flow 600 that supports registration of service preferences and capabilities in accordance with one or more aspects of the present disclosure. The process flow 600 may implement or may be implemented by aspects of the wireless communications system 100, the network architecture 200, the wireless communications system 300, the process flow 400, or the process flow 500. For example, the process flow 600 may include a UE 115 (e.g., a UE 115-b) and a network entity 105 (e.g., a network entity 105-d), which may be examples of the corresponding devices as described with reference to FIG. 1. While the operations of the process flow 600 are described with reference to a DSS 601, the process flow 600 may also be used by one or more other network provided services (e.g., an AMS, topology management service, subscription services).

In the following description of the process flow 600, the operation between the UE 115-b, the network entity 105-d, the DSS 601, the delegation service 602, the service modules 603, and the subscription service 604 may be transmitted in a different order shown. Some operations may also be omitted from the process flow 600, and other operations may be added to the process flow 600. Further, although some operations or signaling may be shown to occur at different times for discussion purposes, these operations may occur at the same time.

In some examples, the delegation service 602 may be implemented at (e.g., co-located with) the network entity 105-d (e.g., a RAN node), the DSS 601, the subscription service 504, the OAM, the SMO, or one or more other services (e.g., the service modules 603). In such examples, the operations or signaling shown between the devices of the process flow 600 may be between different devices than illustrated. For example, if the delegation service 602 is implemented at the subscription service 604, the DSS 601 may transmit a service preference enquiry to the subscription service 604. In some examples, the delegation service 602 may be a separate network service (e.g., not co-located with one or more other services or entities), as illustrated with reference to the process flow 600.

In some examples, the delegation service 602 may be more than one entity. For example, the delegation service 602 may be a first delegation service for UE 115 service preference and/or UE-provided service information, and a second delegation service for network (e.g., network operator, OAM, SMO) service preference information. In such examples, the DSS 601 or one or more other network-provided service entities may communicate service establishment messages, service enquiry messages, subscription requests, service information, and so on with both of the first delegation service and the second delegation service.

At 605, the UE 115-b may establish a connection with the network entity 105-d (e.g., a RAN node). For example, the UE 115-c may determine if AS and NAS security is active. At 610, the UE 115-c may transmit, to the network entity 105-d, an AS transport message indicating a service selection ID (e.g., identifying the DSS 601 as being a selection service for the UE 115-b and requesting for the network entity 105-d to provide one or more service IDs). In some examples, the AS transport message or one or more other messages may indicate an ID of the UE 115-c.

At 615, the network entity 105-d may transmit the selection service ID and UE information (e.g., including the ID of the UE 115-c) to the DSS 601. In some examples, the network entity 105-d may also transmit one or more service preferences (e.g., RAN service preferences) to the DSS 601 for facilitating service selection.

At 620, the DSS 601 may select one or more services (e.g., one or more services associated with the service selection ID). In some examples (e.g., if the delegation service is implemented at or co-located with the DSS 601), the DSS 601 may consider available preferences of the UE 115-c, the network entity 105-d, a network operator (e.g., an OAM or SMO), and so on to select the services. In some examples, the DSS 601 may perform selection of one or more UEs 115 to configure with UE-provided services based on the list of services provided by the UE 115-c (e.g., and one or more other lists of services provided by UEs 115).

At 625, the DSS 501 may transmit, to the subscription service 604, a request to check subscription information related to the selected services (e.g., UE 115-c subscription information). The subscription service 604 may provide the subscription information for the selected services in response to the request to the DSS 601.

At 630, DSS 601 may retrieve (e.g., receive, obtain), from the service modules 603, service profile information for the selected services. For example, the DSS 601 may transmit a service profile enquiry to the service modules 603 and may receive the service profile information in response to the enquiry. The DSS 601 may output, to the network entity 105-d, the service profile information (e.g., service IDs, one or more functionalities supported by the UE 115-c, routing information, and so on).

At 635, the DSS 601 may output, to the delegation service 602, a service preference enquiry requesting a list of service provided by the UE 115-c, service preference information for the UE 115-c (e.g., and/or for a network operator, OAM, SMO), or both. In some examples, the service preference enquiry (e.g., or a separate message) may include a subscription to changes in the list of services or the service preference information (e.g., a flag indicating for the delegation service 602 to provide updates to the list of services and the service preference information).

At 640, the DSS 601 may retrieve (e.g., receive, obtain) the list of services provided by the UE 115-c, service preference information for the UE 115-c (e.g., and/or for a network operator, OAM, SMO), or both from the delegation service 602 in response to the service preference enquiry. In some examples, the network entity 105-c may obtain one or more updates to the list of services or the service preference information (e.g., in response to the subscription).

At 645, the DSS 601 may determine a prioritization for configuring the UE 115-c with one or more services (e.g., UE-provided or network-provided services) or functionalities. For example, the DSS 601 may consider the list of services provided by the UE 115-c and/or the service preference information of the UE 115-c, the network entity 105-d, a network operator (e.g., an OAM or SMO), and so on to determine an overall service or function prioritization.

At 650, the DSS 601 may transmit (e.g., output) a service profile or service priority information indicating a service profile of a first service of the list of services provided by the UE 115-c, a first network service, and so on based on determining the prioritization. In some examples, the service priority information or the service profile configuration may include one or more service IDs, supported functionalities, service or functionality prioritization information, routing information, and so on. In some examples, the DSS 601 may transmit the service profile or priority information to the network entity 105-c for forwarding to the UE 115-c. In some examples, the service profile or priority information may be non-transparent to the network entity 105-d.

In some examples, the DSS 601 may configure the UE 115-c with a UE- or network-provided service based on the prioritization information. In some examples, the UE 115-c may make a selection of one or more services (e.g., UE- or network-provided services) to provide or use based on the prioritization, service preference information, and service profile information (e.g., among one or more advertised service IDs of the service profile information). The UE 115-c may communicate service data with the network entity 105-d or the DSS 601 in accordance with the configuration. For example, the UE 115-c may use or provide one or more services in accordance with the configuration.

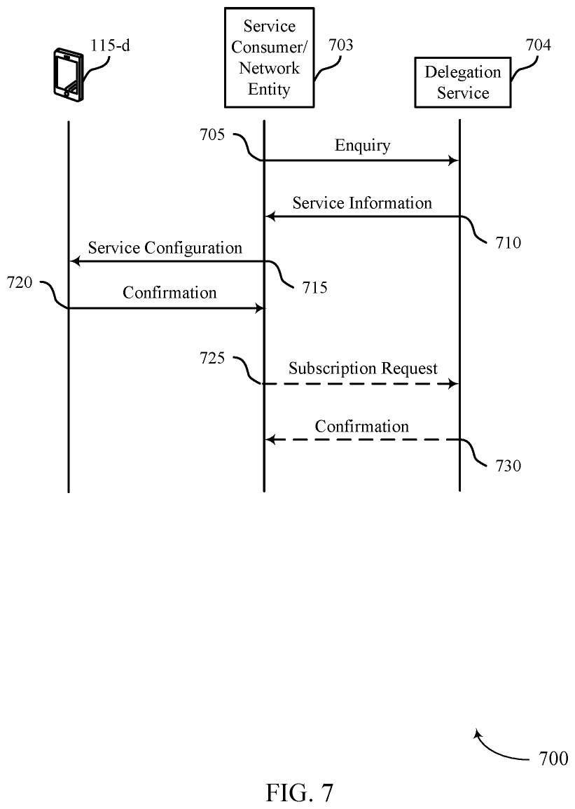

FIG. 7 shows an example of a process flow 700 that supports registration of service preferences and capabilities in accordance with one or more aspects of the present disclosure. The process flow 700 may implement or may be implemented by aspects of the wireless communications system 100, the network architecture 200, the wireless communications system 300, the process flow 400, the process flow 500, or the process flow 600. For example, the process flow 700 may include a UE 115 (e.g., a UE 115-d) and a network entity 105, which may be examples of the corresponding devices as described with reference to FIG. 1.

In the following description of the process flow 700, the operation between the UE 115-d, the service consumer (e.g., network consumer service) or network entity (e.g., RAN node) 703, and the delegation service 704 (e.g., a UE delegation service) may be transmitted in a different order shown. Some operations may also be omitted from the process flow 700, and other operations may be added to the process flow 700. Further, although some operations or signaling may be shown to occur at different times for discussion purposes, these operations may occur at the same time. In some examples, the service consumer or network entity 703 may be a RAN node or another network service (e.g., a DSS, another RAN entity, an access and mobility service, a topology management service, a subscription service, and so on).

In some examples, the delegation service 704 may be implemented at (e.g., co-located with) a network entity 105 (e.g., a RAN node), a DSS, a subscription service, an OAM, an SMO, or one or more other services or service consumers. In such examples, the operations or signaling shown between the devices of the process flow 700 may be between different devices than illustrated. In some examples, the delegation service 704 may be a separate network service (e.g., not co-located with one or more other services or entities), as illustrated with reference to the process flow 700.

At 705, the service consumer or network entity 703 may transmit, to the delegation service 704, a service enquiry message requesting information from a list of services provided by the UE 115-d and one or more other UEs 115. For example, the service enquiry message may indicate one or more UE IDs and/or an ID of a UE-provided service to be used by the service consumer or network entity 703.

At 710, the service consumer or network entity 703 may retrieve (e.g., obtain, receive) UE service information from the delegation service 704 (e.g., service information from a list of UE-provided services managed by the delegation service 704). The service information may include one or more UE IDs (e.g., IDs of UEs 115 that may provide a service to the service consumer or network entity 703), one or more IDs of the UE provided services, UE service profile information of the UE provided services, and so on. The service consumer or network entity 703 may select one or more UEs (e.g., the UE 115-d) to configure with one or more UE provided services based on the UE service information.

At 715, the service consumer or network entity 703 may transmit a service configuration message (e.g., service establishment) to the UE 115-d to configure the UE 115-d with the one or more UE provided services. The service configuration message may include a service ID of the one or more UE-provided services (e.g., UE-provided services that the service consumer or network entity 703 select to be provided to the service consumer or network entity 703), a periodicity for the UE 115-d to report one or more metrics related to the UE-provided services, one or more events or triggers for the UE 115-d to report the one or more metrics, and so on. At 720, the UE 115-d may transmit a response or confirmation message to the service consumer or network entity 703 in response to the service configuration message.

At 725, the service consumer or network entity 703 may output (e.g., transmit), to the delegation service 704, a subscription request to subscribe to changes in the list of services provided by the UE 115-d. In some examples, the subscription request may be part of (e.g., a flag in) the service enquiry message. At 730, the delegation service 704 may transmit a confirmation message to confirm that the service consumer or network entity 703 will receive the updates to the list of services provided by the UE 115-d.

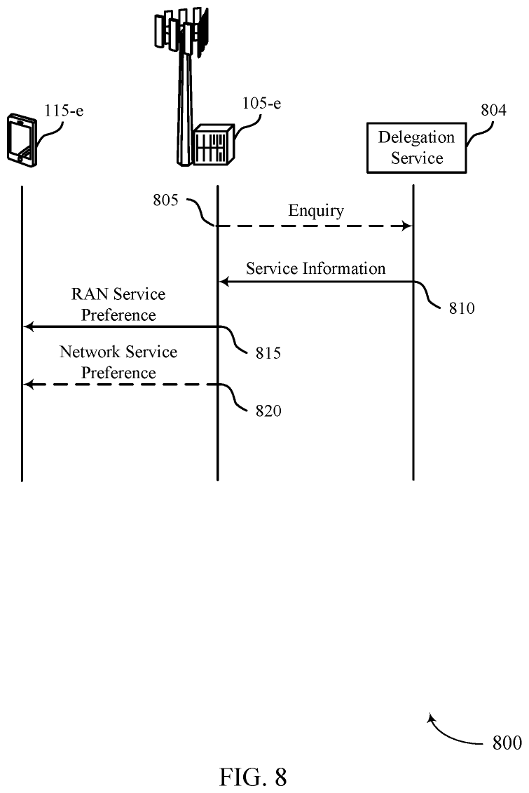

FIG. 8 shows an example of a process flow 800 that supports registration of service preferences and capabilities in accordance with one or more aspects of the present disclosure. The process flow 800 may implement or may be implemented by aspects of the wireless communications system 100, the network architecture 200, the wireless communications system 300, the process flow 400, the process flow 500, the process flow 600, or the process flow 700. For example, the process flow 800 may include a UE 115 (e.g., a UE 115-e) and a network entity 105 (e.g., a network entity 105-e), which may be examples of the corresponding devices as described with reference to FIG. 1.

In the following description of the process flow 800, the operation between the UE 115-e, the network entity 105-e, and the delegation service 804 may be transmitted in a different order shown. Some operations may also be omitted from the process flow 800, and other operations may be added to the process flow 800. Further, although some operations or signaling may be shown to occur at different times for discussion purposes, these operations may occur at the same time.

In some examples, the delegation service 804 may be implemented at (e.g., co-located with) a network entity 105 (e.g., the network entity 105-e, a RAN node), a DSS, a subscription service, an OAM, an SMO, or one or more other services or service consumers. In such examples, the operations or signaling shown between the devices of the process flow 800 may be between different devices than illustrated. In some examples, the delegation service 804 may be a separate network service (e.g., not co-located with one or more other services or entities), as illustrated with reference to the process flow 800.

In some examples, at 805, the network entity 105-e may output, to the delegation service 804, a network service preference enquiry. The network service preference enquiry message may request for the delegation service 804 to provide one or more network or operator preferences (e.g., preferences from an OAM or SMO) managed by the delegation service 804. The network service preference enquiry may include an indication of one or more UE IDs (e.g., an ID of the UE 115-e) for which the network entity 105-e is requesting network preference information, one or more service IDs for which the network entity 105-e is requesting network service preference information, or both.

At 810, the delegation service 804 may provide (e.g., output, transmit) service preference information to the network entity 105-e (e.g., in response to the enquiry or autonomously). The service preference information may include, for example, the UE IDs, the service IDs, and one or more network (e.g., operator, OAM, SMO) preferences associated with the service IDs. In some examples, the network entity 105-e may use the network service preference information to determine a RAN service preference (e.g., a service preference of the network entity 105-e) or to determine a service prioritization of one or more UE- or network-provided services.

At 815, the network entity 105-e may output, to the UE 115-e, an indication of the RAN service preference information (e.g., or service preference information for one or more other devices in a wireless network). In some examples, the RAN service preference information may be an outcome of a combination of RAN and network (e.g., operator) service preferences. In some examples, at 820, the network entity 105-e may transmit the network service preference information to the UE 115-e (e.g., separate from the RAN service preference information). The UE 115-e may communicate service data with the network entity 105-e in accordance with the RAN and network preferences and one or more UE preferences.

FIG. 9 shows an example of a process flow 900 that supports registration of service preferences and capabilities in accordance with one or more aspects of the present disclosure. The process flow 900 may implement or may be implemented by aspects of the wireless communications system 100, the network architecture 200, the wireless communications system 300, the process flow 400, the process flow 500, the process flow 600, the process flow 700, or the process flow 800. For example, the process flow 900 may include a UE 115 (e.g., a UE 115-f) and a network entity 105 (e.g., a network entity 105-f), which may be examples of the corresponding devices as described with reference to FIG. 1. While the operations of the process flow 900 are described with reference to a DSS or service module 903, the process flow 900 may also be used by one or more other network provided services (e.g., an AMS, topology management service, subscription services).

In the following description of the process flow 900, the operation between the UE 115-f, the network entity 105-f, the DSS or service module 903, and the delegation service 904 may be transmitted in a different order shown. Some operations may also be omitted from the process flow 900, and other operations may be added to the process flow 900. Further, although some operations or signaling may be shown to occur at different times for discussion purposes, these operations may occur at the same time.

In some examples, the delegation service 904 may be implemented at (e.g., co-located with) the network entity 105-f (e.g., a RAN node), the DSS or service module 903, a subscription service, an OAM, an SMO, or one or more other services. In such examples, the operations or signaling shown between the devices of the process flow 900 may be between different devices than illustrated. For example, if the delegation service 904 is implemented at the DSS or service module 903, the network entity 105-f may receive service preference updates from the DSS or service module 903. In some examples, the delegation service 904 may be a separate network service (e.g., not co-located with one or more other services or entities), as illustrated with reference to the process flow 900.

In some examples, the delegation service 904 may be more than one entity. For example, the delegation service 904 may be a first delegation service for UE 115 service preference and/or UE-provided service information, and a second delegation service for network (e.g., network operator, OAM, SMO) service preference information. In such examples, the network entity 105-f, the DSS or service module 903, or one or more other network-provided service entities may communicate service establishment messages, service enquiry messages, subscription requests, service information, and so on with both of the first delegation service and the second delegation service.

At 905, the delegation service 904 may receive or identify an update to service preference information (e.g., UE 115 service preference information or network, operator, OAM, or SMO service preference information) or an update to a list of services provided by the UE 115-f. For example, the delegation service may receive an indication of the update to the service preference information or the list of services from the UE 115-f or from the OAM or SMO.

In some examples, at 910, the delegation service 904 may output, to the network entity 105-f, the DSS or service module 903, or one or more other consumers of UE- or network-provided services, an indication of the updated service preference information and/or the updated list of services. In some examples, the delegation service 904 may output the updated service preference information autonomously or in response to receiving a subscription request from the network entity 105-f or the DSS or service module 903.

In some examples, at 915, the network entity 105-f, the DSS or service module 903, or one or more other consumers of UE- or network-provided services may receive the indication of the updated service preference information and/or the updated list of services from UE 115-f (e.g., rather than or in addition to the indication from the delegation service 904). In some examples, the UE 115-f may output the updated service preference information autonomously or in response to receiving a request from the network entity 105-f or the DSS or service module 903 for the updated service preference information.

At 920, one or more of the network entity 105-f, the DSS or service module 903, or the one or more other consumers of the UE- or network-provided services may transmit one or more LCM control signals to the UE 115-f (e.g., based on the updated service preference information or the updated list of services provided by the UE 115-f). The LCM control signals may indicate for the UE 115-f to activate, fallback, or switch configurations (e.g., or reconfigurations) of one or more services (e.g., UE- or network-provided services). For example, the LCM control signals may indicate a configuration or reconfiguration of the one or more services or a release of the one or more services. In some examples, the LCM control signals may indicate for the UE 115-f to communicate service data with the network entity 105-f, the DSS or service module 903, or some combination thereof.

FIG. 10 shows an example of a wireless communications system 1000 that supports registration of service preferences and capabilities in accordance with one or more aspects of the present disclosure. The wireless communications system 1000 may implement or may be implemented by aspects of the wireless communications system 100, the network architecture 200, the wireless communications system 300, the process flow 400, the process flow 500, the process flow 600, the process flow 700, the process flow 800, or the process flow 900. For example, the wireless communications system 1000 may include a UE 115 (e.g., a UE 115-g) and a network entity 105, which may be examples of the corresponding devices as described with reference to FIG. 1. While the wireless communications system 1000 is described with reference to a DSS or network entity 1003, the wireless communications system 1000 may also be implemented by one or more other network provided services (e.g., an AMS, topology management service, subscription services).

In some examples, as described herein with reference to FIGS. 3 through 9, a delegation service 1004 (e.g., a UE delegation service 1004) may manage a list of services 1010 that a UE 115-g is capable of providing, service preference information 1015 of the UE 115-g (e.g., or one or more other entities of the wireless communications system 1000, such as an OAM or SMO), or both. For example, the UE 115-g may transmit a service establishment request 1005 requesting for the delegation service 1004 to manage the list of services 1010 and/or the service preference information 1015. The UE 115-g may accordingly transmit the list of services 1010 and the service preference information 1015 to the delegation service 1004.

An entity of the wireless communications system 1000 (e.g., a DSS or network entity 1003 or one or more other network-provided services) may transmit a service preference enquiry 1020 to the delegation service 1004. The delegation service 1004 may accordingly transmit the list of services 1010 and/or the service preference information 1015 to the DSS or network entity 1003.

In some examples, the UE 115-g may identify one or more updates 1030 to the list of services 1010 and/or the service preference information 1015. The UE 115-g may indicate the updates 1030 to the delegation service 1004. The delegation service 1004 may therefore output an indication of the updates 1030 to the DSS or network entity 1003. In some examples, the delegation service 1004 may output the indication of the updates 1030 in response to a subscription request 1035 (e.g., in the service preference enquiry 1020 or in a separate message from the DSS or network entity 1003).

The DSS or network entity 1003 may transmit a service configuration 1025 to the UE 115-g in response to the list of services 1010, the service preference information 1015, the updates 1030, or some combination thereof. The service configuration 1025 may configure the UE 115-g to provide one or more services of the list of services 1010 or to use one or more services based on the service preference information 1015.

In some examples, the delegation service 1004 may be implemented at (e.g., co-located with) the DSS or network entity 1003 (e.g., a RAN node), a subscription service, an OAM, an SMO, or one or more other services. In such examples, the operations or signaling shown between the devices of the wireless communication system 1000 may be between different devices than illustrated. In some examples, the delegation service 1004 may be a separate network service (e.g., not co-located with one or more other services or entities), as illustrated with reference to the wireless communications system 1000.

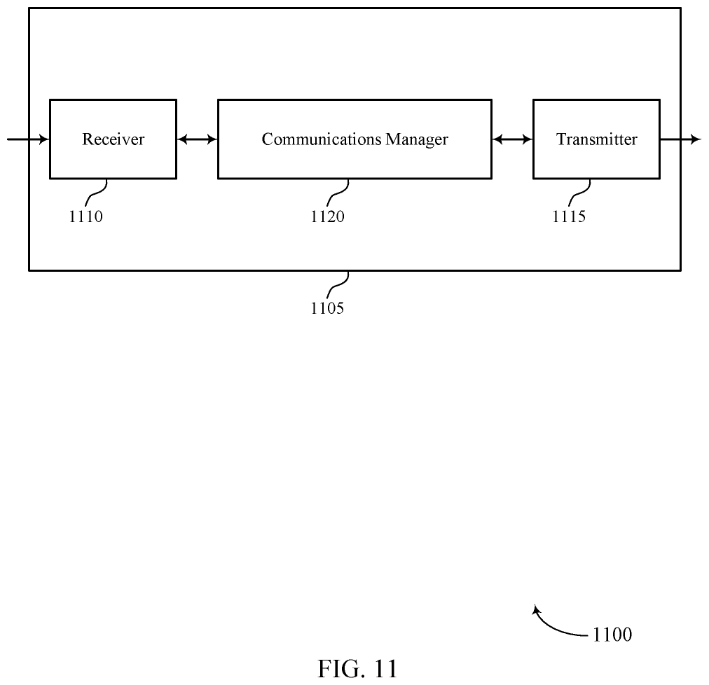

FIG. 11 shows a block diagram 1100 of a device 1105 that supports registration of service preferences and capabilities in accordance with one or more aspects of the present disclosure. The device 1105 may be an example of aspects of a network entity 105 or a delegation service (e.g., a UE delegation service) as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of registration of service preferences and capabilities as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be an example of means for managing service preference and capability information. The communications manager 1120, the receiver 1110, the transmitter 1115, or various combinations or components thereof may be implemented in hardware (e.g., in communications management circuitry). The circuitry may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services. The communications manager 1120 is capable of, configured to, or operable to support a means for obtaining a service preference enquiry requesting the list of services provided by the device, the service preference information for the device, or both. The communications manager 1120 is capable of, configured to, or operable to support a means for outputting, to the network entity or the one or more other network provided services, the list of services provided by the device, the service preference information for the device, or both.

Additionally, or alternatively, the communications manager 1120 may support wireless communications in accordance with examples as disclosed herein. For example, the communications manager 1120 is capable of, configured to, or operable to support a means for outputting a service preference enquiry requesting a list of services provided by a device in a wireless network, service preference information for the device, or both. The communications manager 1120 is capable of, configured to, or operable to support a means for obtaining the list of services provided by the device, the service preference information for the device, or both. The communications manager 1120 is capable of, configured to, or operable to support a means for outputting, to the device, a service profile configuration that indicates a first service of the list of services provided by the device or a first network service based on the list of services provided by the device or the service preference information.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for managing service preference and capability information, which may allow for reduced processing, reduced power consumption, and more efficient utilization of communication resources.

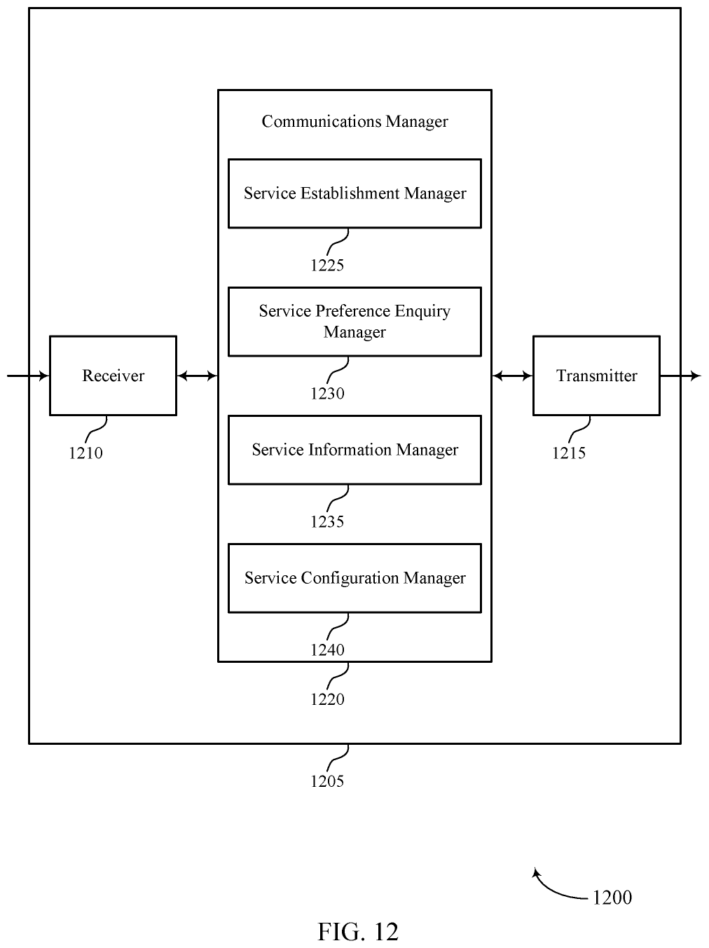

FIG. 12 shows a block diagram 1200 of a device 1205 that supports registration of service preferences and capabilities in accordance with one or more aspects of the present disclosure. The device 1205 may be an example of aspects of a device 1105, a network entity 105, or a delegation service (e.g., a UE delegation service) as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of registration of service preferences and capabilities as described herein. For example, the communications manager 1220 may include a service establishment manager 1225, a service preference enquiry manager 1230, a service information manager 1235, a service configuration manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The service establishment manager 1225 is capable of, configured to, or operable to support a means for obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services. The service preference enquiry manager 1230 is capable of, configured to, or operable to support a means for obtaining a service preference enquiry requesting the list of services provided by the device, the service preference information for the device, or both. The service information manager 1235 is capable of, configured to, or operable to support a means for outputting, to the network entity or the one or more other network provided services, the list of services provided by the device, the service preference information for the device, or both.

Additionally, or alternatively, the communications manager 1220 may support wireless communications in accordance with examples as disclosed herein. The service preference enquiry manager 1230 is capable of, configured to, or operable to support a means for outputting a service preference enquiry requesting a list of services provided by a device in a wireless network, service preference information for the device, or both. The service information manager 1235 is capable of, configured to, or operable to support a means for obtaining the list of services provided by the device, the service preference information for the device, or both. The service configuration manager 1240 is capable of, configured to, or operable to support a means for outputting, to the device, a service profile configuration that indicates a first service of the list of services provided by the device or a first network service based on the list of services provided by the device or the service preference information.

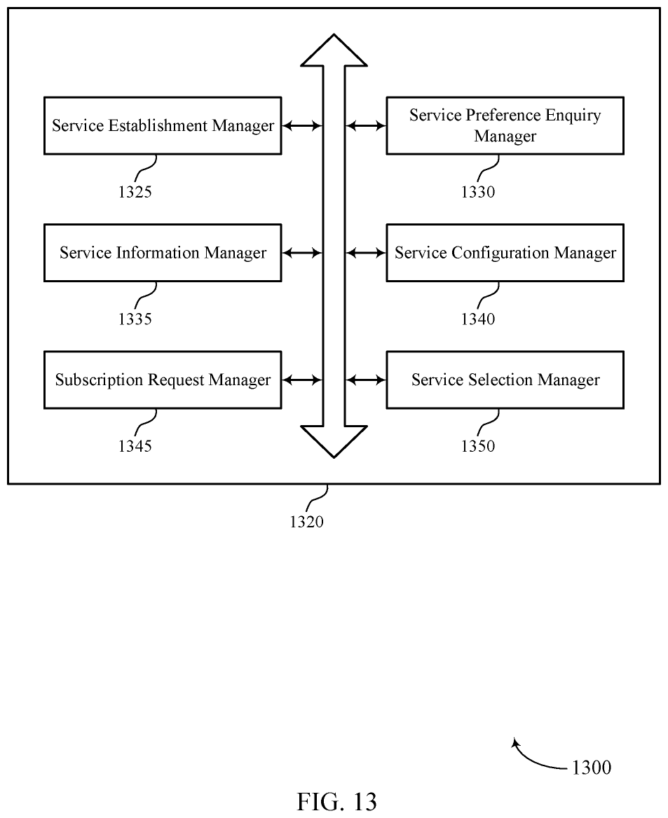

FIG. 13 shows a block diagram 1300 of a communications manager 1320 that supports registration of service preferences and capabilities in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of registration of service preferences and capabilities as described herein. For example, the communications manager 1320 may include a service establishment manager 1325, a service preference enquiry manager 1330, a service information manager 1335, a service configuration manager 1340, a subscription request manager 1345, a service selection manager 1350, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The service establishment manager 1325 is capable of, configured to, or operable to support a means for obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services. The service preference enquiry manager 1330 is capable of, configured to, or operable to support a means for obtaining a service preference enquiry requesting the list of services provided by the device, the service preference information for the device, or both. The service information manager 1335 is capable of, configured to, or operable to support a means for outputting, to the network entity or the one or more other network provided services, the list of services provided by the device, the service preference information for the device, or both.

In some examples, the service information manager 1335 is capable of, configured to, or operable to support a means for obtaining an update to the list of services provided by the device, an update to the service preference information for the device, or both. In some examples, the service information manager 1335 is capable of, configured to, or operable to support a means for outputting, to the network entity or the one or more other network provided services, the updated list of services provided by the device, the updated service preference information, or both.

In some examples, the subscription request manager 1345 is capable of, configured to, or operable to support a means for obtaining a subscription request indicating for the UE delegation service to output, to the network entity or the one or more other network provided services, one or more changes in the list of services provided by the device or the service preference information for the device.

In some examples, the service preference information for the device includes service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

In some examples, the service preference enquiry manager 1330 is capable of, configured to, or operable to support a means for obtaining, from a service consumer, a second service preference enquiry requesting the list of services provided by the device. In some examples, the service information manager 1335 is capable of, configured to, or operable to support a means for outputting, to the service consumer, the list of services provided by the device and one or more of an identity of the device, service ID information, and service profile information for the list of services provided by the device.

In some examples, the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

In some examples, the UE delegation service is implemented at a DSS, at the network entity, at a subscription service, or at the one or more other network provided services.

In some examples, the service preference enquiry includes one or more of an ID of the device, one or more service IDs of one or more services, or any combination thereof.

In some examples, the device includes an OAM entity, a SMO entity, or a UE.

Additionally, or alternatively, the communications manager 1320 may support wireless communications in accordance with examples as disclosed herein. In some examples, the service preference enquiry manager 1330 is capable of, configured to, or operable to support a means for outputting a service preference enquiry requesting a list of services provided by a device in a wireless network, service preference information for the device, or both. In some examples, the service information manager 1335 is capable of, configured to, or operable to support a means for obtaining the list of services provided by the device, the service preference information for the device, or both. The service configuration manager 1340 is capable of, configured to, or operable to support a means for outputting, to the device, a service profile configuration that indicates a first service of the list of services provided by the device or a first network service based on the list of services provided by the device or the service preference information.

In some examples, the service preference enquiry includes one or more of an ID of the device, one or more service IDs of one or more services, or any combination thereof.

In some examples, the subscription request manager 1345 is capable of, configured to, or operable to support a means for outputting a subscription request indicating for the UE delegation service to output, to the network entity, one or more changes in the list of services provided by the device or the service preference information for the device.

In some examples, the service preference information for the device includes service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

In some examples, the service profile configuration includes a service ID, service prioritization information, a periodicity associated with reporting information related to one or more services, an indication of one or more triggers for reporting the information related to one or more services, or any combination thereof.

In some examples, the service selection manager 1350 is capable of, configured to, or operable to support a means for obtaining, from a second network entity, an ID of the device and a selection service ID that identifies the network entity as being a selection service for the device. In some examples, the service selection manager 1350 is capable of, configured to, or operable to support a means for selecting one or more services for the device based on the ID of the device and the selection service ID. In some examples, the service selection manager 1350 is capable of, configured to, or operable to support a means for outputting, to the second network entity, an indication of one or more service IDs of the one or more services, one or more supported functions of the one or more services, routing information associated with the one or more services, or any combination thereof.

In some examples, the service selection manager 1350 is capable of, configured to, or operable to support a means for outputting, to a DSS, an ID of the device and a selection service ID that identifies the DSS as being a selection service for the device. In some examples, the service selection manager 1350 is capable of, configured to, or operable to support a means for obtaining, from the DSS, an indication of one or more service IDs of one or more services selected for the device, one or more supported functions of the one or more services, routing information associated with the one or more services, or any combination thereof.

In some examples, the service information manager 1335 is capable of, configured to, or operable to support a means for outputting, to the device, an indication of service preference information for one or more additional devices in the wireless network.

In some examples, the service configuration manager 1340 is capable of, configured to, or operable to support a means for obtaining, from the device, an acknowledgement message in response to the service profile configuration.

In some examples, the network entity includes a DSS, a radio access network entity, an access and mobility service, a topology management service, a subscription service, or one or more other network provided services.

In some examples, the device includes an OAM entity, a SMO entity, or a UE.

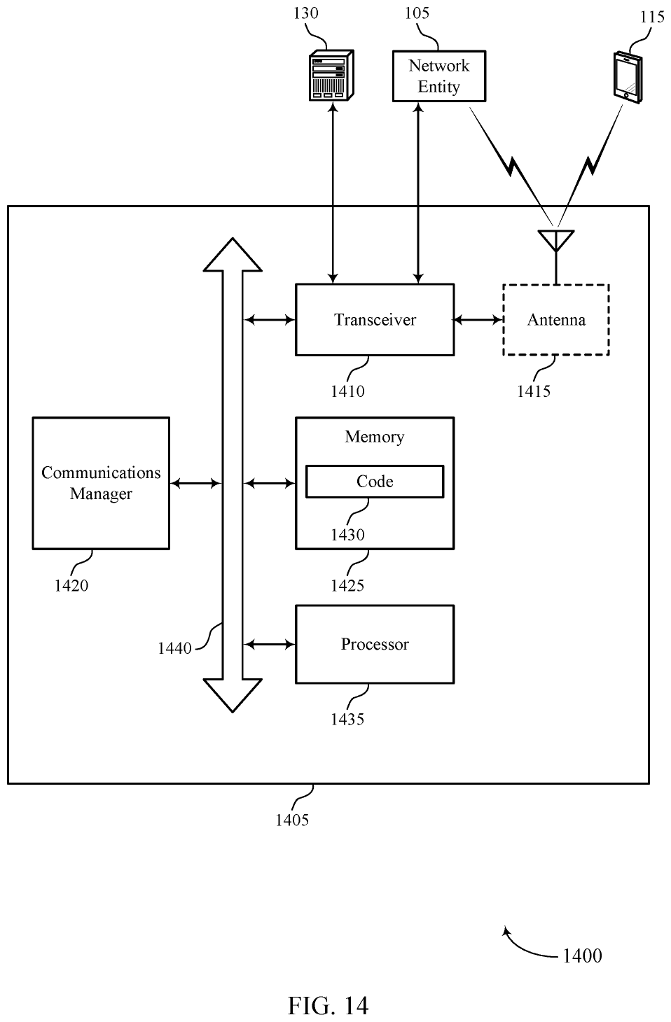

FIG. 14 shows a diagram of a system 1400 including a device 1405 that supports registration of service preferences and capabilities in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting registration of service preferences and capabilities). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services. The communications manager 1420 is capable of, configured to, or operable to support a means for obtaining a service preference enquiry requesting the list of services provided by the device, the service preference information for the device, or both. The communications manager 1420 is capable of, configured to, or operable to support a means for outputting, to the network entity or the one or more other network provided services, the list of services provided by the device, the service preference information for the device, or both.

Additionally, or alternatively, the communications manager 1420 may support wireless communications in accordance with examples as disclosed herein. For example, the communications manager 1420 is capable of, configured to, or operable to support a means for outputting a service preference enquiry requesting a list of services provided by a device in a wireless network, service preference information for the device, or both. The communications manager 1420 is capable of, configured to, or operable to support a means for obtaining the list of services provided by the device, the service preference information for the device, or both. The communications manager 1420 is capable of, configured to, or operable to support a means for outputting, to the device, a service profile configuration that indicates a first service of the list of services provided by the device or a first network service based on the list of services provided by the device or the service preference information.

By including or configuring the communications manager 1420 in accordance with examples as described herein, the device 1405 may support techniques for managing service preference and capability information, which may allow for improved communication reliability, improved user experience related to reduced processing, reduced power consumption, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of registration of service preferences and capabilities as described herein, or the at least one processor 1435 and the at least one memory 1425 may be otherwise configured to, individually or collectively, perform or support such operations.

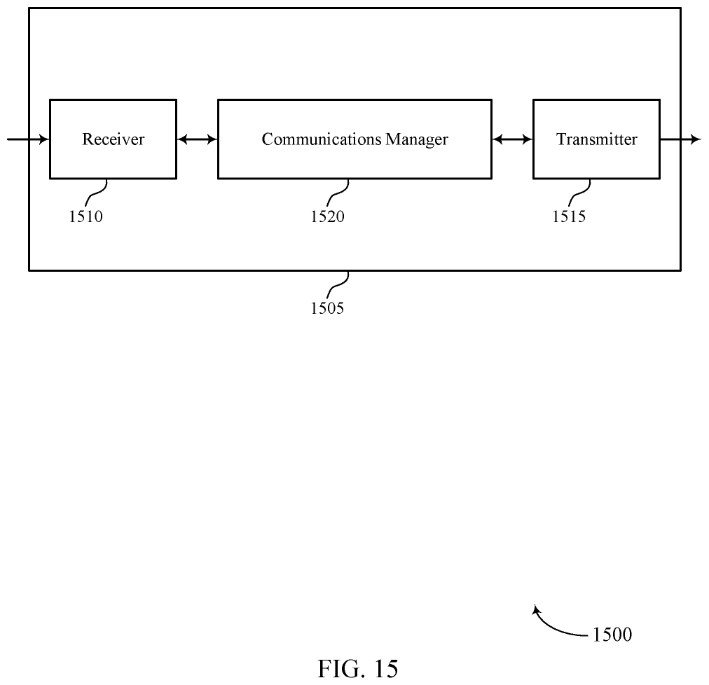

FIG. 15 shows a block diagram 1500 of a device 1505 that supports registration of service preferences and capabilities in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, and the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to registration of service preferences and capabilities). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to registration of service preferences and capabilities). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of registration of service preferences and capabilities as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be an example of means for managing service preference and capability information. The communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor. If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for transmitting a service establishment request message requesting for the UE delegation service to manage a list of services provided by the device, to manage service preference information for the device, or both, for coordinating with a network entity, one or more other network provided services, or any combination of the network entity and the one or more other network provided services. The communications manager 1520 is capable of, configured to, or operable to support a means for receiving a service profile configuration that configures the device to provide a first service of the list of services provided by the device or a first network service based on the list of services provided by the device or the service preference information. The communications manager 1520 is capable of, configured to, or operable to support a means for communicating service data in accordance with the service profile configuration.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for managing service preference and capability information, which may allow for reduced processing, reduced power consumption, and more efficient utilization of communication resources.

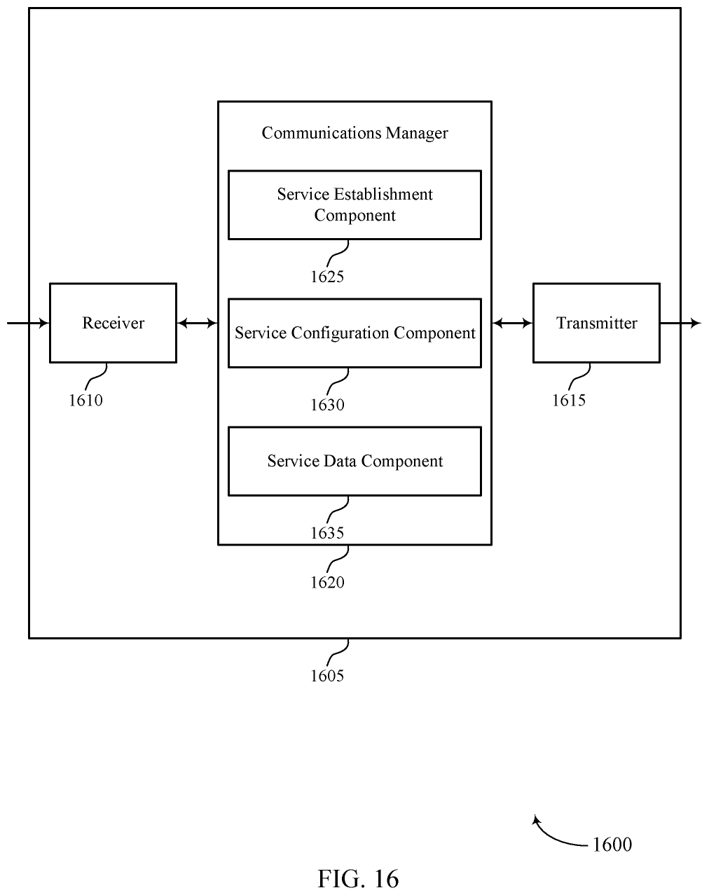

FIG. 16 shows a block diagram 1600 of a device 1605 that supports registration of service preferences and capabilities in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605, or one or more components of the device 1605 (e.g., the receiver 1610, the transmitter 1615, and the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to registration of service preferences and capabilities). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to registration of service preferences and capabilities). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of registration of service preferences and capabilities as described herein. For example, the communications manager 1620 may include a service establishment component 1625, a service configuration component 1630, a service data component 1635, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The service establishment component 1625 is capable of, configured to, or operable to support a means for transmitting a service establishment request message requesting for the UE delegation service to manage a list of services provided by the device, to manage service preference information for the device, or both, for coordinating with a network entity, one or more other network provided services, or any combination of the network entity and the one or more other network provided services. The service configuration component 1630 is capable of, configured to, or operable to support a means for receiving a service profile configuration that configures the device to provide a first service of the list of services provided by the device or a first network service based on the list of services provided by the device or the service preference information. The service data component 1635 is capable of, configured to, or operable to support a means for communicating service data in accordance with the service profile configuration.

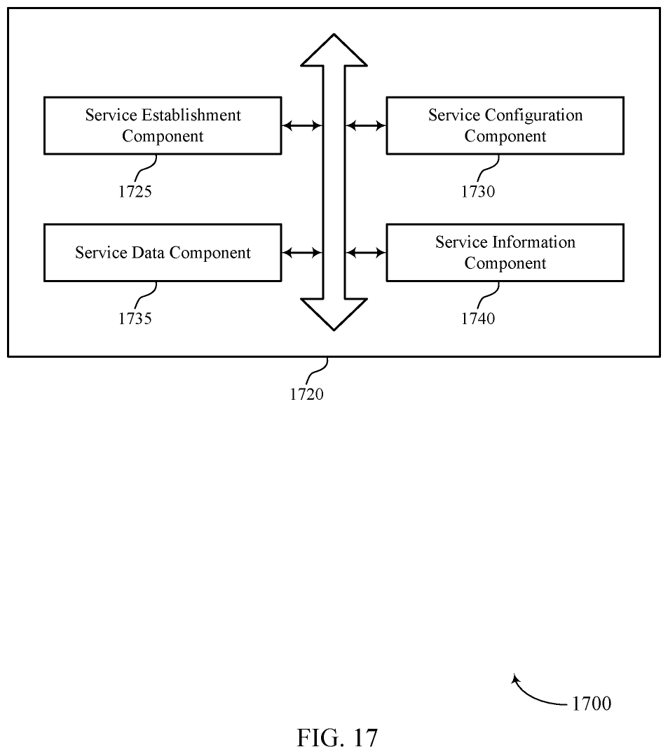

FIG. 17 shows a block diagram 1700 of a communications manager 1720 that supports registration of service preferences and capabilities in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of registration of service preferences and capabilities as described herein. For example, the communications manager 1720 may include a service establishment component 1725, a service configuration component 1730, a service data component 1735, a service information component 1740, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The service establishment component 1725 is capable of, configured to, or operable to support a means for transmitting a service establishment request message requesting for the UE delegation service to manage a list of services provided by the device, to manage service preference information for the device, or both, for coordinating with a network entity, one or more other network provided services, or any combination of the network entity and the one or more other network provided services. The service configuration component 1730 is capable of, configured to, or operable to support a means for receiving a service profile configuration that configures the device to provide a first service of the list of services provided by the device or a first network service based on the list of services provided by the device or the service preference information. The service data component 1735 is capable of, configured to, or operable to support a means for communicating service data in accordance with the service profile configuration.

In some examples, the service information component 1740 is capable of, configured to, or operable to support a means for transmitting, to the UE delegation service, an update to the list of services provided by the device, an update to the service preference information for the device, or both based on a change in the list of services provided by the device, a change in the service preference information for the device, a change in geographical location of the device, or any combination thereof.

In some examples, the service preference information for the device includes service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

In some examples, the service profile configuration includes a service ID, service prioritization information, a periodicity associated with reporting information related to one or more services, an indication of one or more triggers for reporting the information related to one or more services, or any combination thereof.

In some examples, the service information component 1740 is capable of, configured to, or operable to support a means for receiving an indication of service preference information for one or more other devices of the wireless network.

In some examples, the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

In some examples, the service configuration component 1730 is capable of, configured to, or operable to support a means for transmitting, to the network entity or the one or more other network provided services, an acknowledgement message in response to the service profile configuration.

In some examples, the device includes an OAM entity, a SMO entity, or a UE.

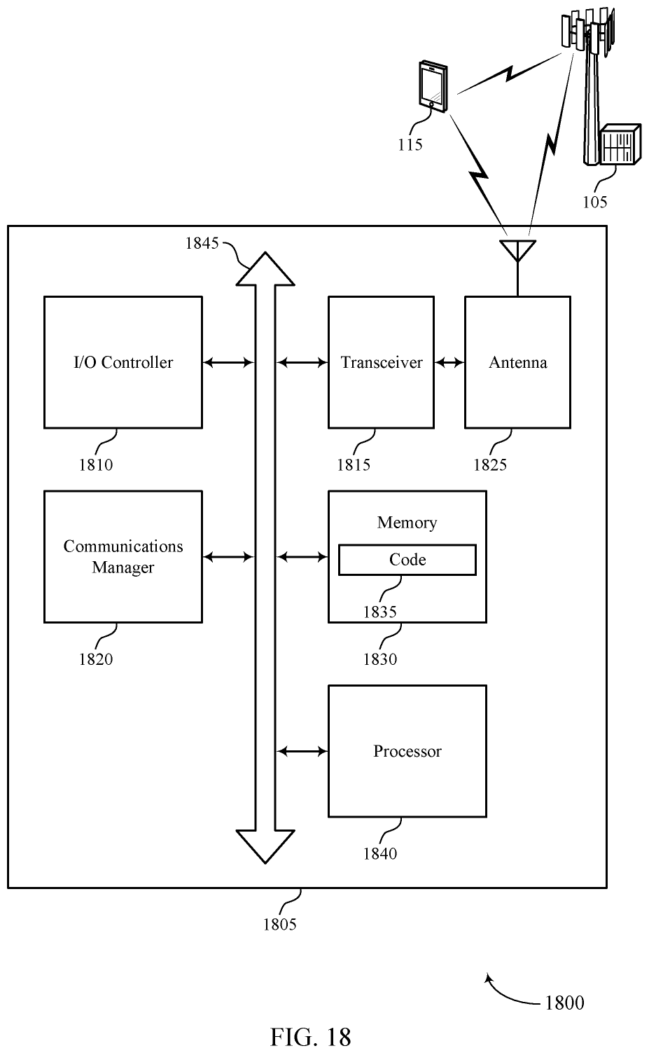

FIG. 18 shows a diagram of a system 1800 including a device 1805 that supports registration of service preferences and capabilities in accordance with one or more aspects of the present disclosure. The device 1805 may be an example of or include the components of a device 1505, a device 1605, or a UE 115 as described herein. The device 1805 may communicate (e.g., wirelessly) with one or more network entities 105, one or more UEs 115, or any combination thereof. The device 1805 may include components for bi-directional voice and data communications including components for transmitting and receiving communications, such as a communications manager 1820, an input/output (I/O) controller 1810, a transceiver 1815, an antenna 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna 1825. However, in some other cases, the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The at least one memory 1830 may include random access memory (RAM) and read-only memory (ROM). The at least one memory 1830 may store computer-readable, computer-executable code 1835 including instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may contain, among other things, a basic I/O system (BIOS) which may control basic hardware or software operation such as the interaction with peripheral components or devices.

The at least one processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting registration of service preferences and capabilities). For example, the device 1805 or a component of the device 1805 may include at least one processor 1840 and at least one memory 1830 coupled with or to the at least one processor 1840, the at least one processor 1840 and at least one memory 1830 configured to perform various functions described herein. In some examples, the at least one processor 1840 may include multiple processors and the at least one memory 1830 may include multiple memories. One or more of the multiple processors may be coupled with one or more of the multiple memories, which may, individually or collectively, be configured to perform various functions herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1830 or otherwise, to perform one or more of the functions described herein.

The communications manager 1820 may support wireless communications in accordance with examples as disclosed herein. For example, the communications manager 1820 is capable of, configured to, or operable to support a means for transmitting a service establishment request message requesting for the UE delegation service to manage a list of services provided by the device, to manage service preference information for the device, or both, for coordinating with a network entity, one or more other network provided services, or any combination of the network entity and the one or more other network provided services. The communications manager 1820 is capable of, configured to, or operable to support a means for receiving a service profile configuration that configures the device to provide a first service of the list of services provided by the device or a first network service based on the list of services provided by the device or the service preference information. The communications manager 1820 is capable of, configured to, or operable to support a means for communicating service data in accordance with the service profile configuration.

By including or configuring the communications manager 1820 in accordance with examples as described herein, the device 1805 may support techniques for managing service preference and capability information, which may allow for improved communication reliability, improved user experience related to reduced processing, reduced power consumption, improved coordination between devices, and improved utilization of processing capability.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of registration of service preferences and capabilities as described herein, or the at least one processor 1840 and the at least one memory 1830 may be otherwise configured to, individually or collectively, perform or support such operations.

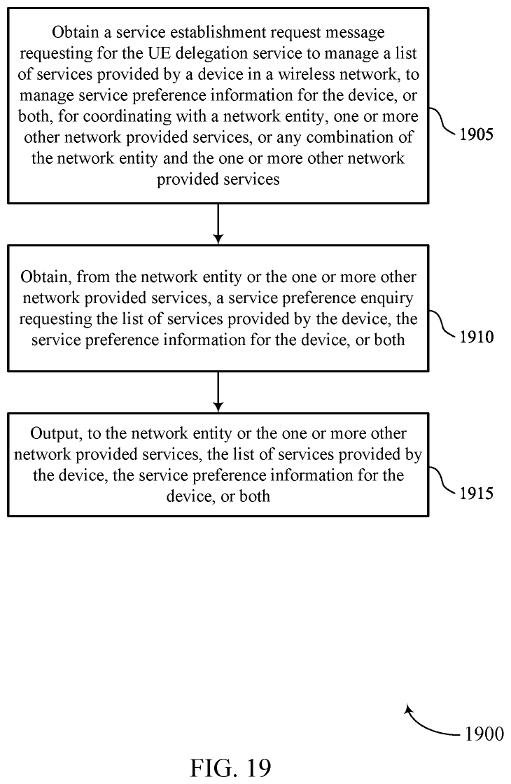

FIG. 19 shows a flowchart illustrating a method 1900 that supports registration of service preferences and capabilities in accordance with one or more aspects of the present disclosure. The operations of the method 1900 may be implemented by a network entity or its components as described herein. For example, the operations of the method 1900 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services. The operations of 1905 may be performed in accordance with examples as disclosed herein. In some examples, aspects of the operations of 1905 may be performed by a service establishment manager 1325 as described with reference to FIG. 13.

At 1910, the method may include obtaining a service preference enquiry requesting the list of services provided by the device, the service preference information for the device, or both. The operations of 1910 may be performed in accordance with examples as disclosed herein. In some examples, aspects of the operations of 1910 may be performed by a service preference enquiry manager 1330 as described with reference to FIG. 13.

At 1915, the method may include outputting, to the network entity or the one or more other network provided services, the list of services provided by the device, the service preference information for the device, or both. The operations of 1915 may be performed in accordance with examples as disclosed herein. In some examples, aspects of the operations of 1915 may be performed by a service information manager 1335 as described with reference to FIG. 13.

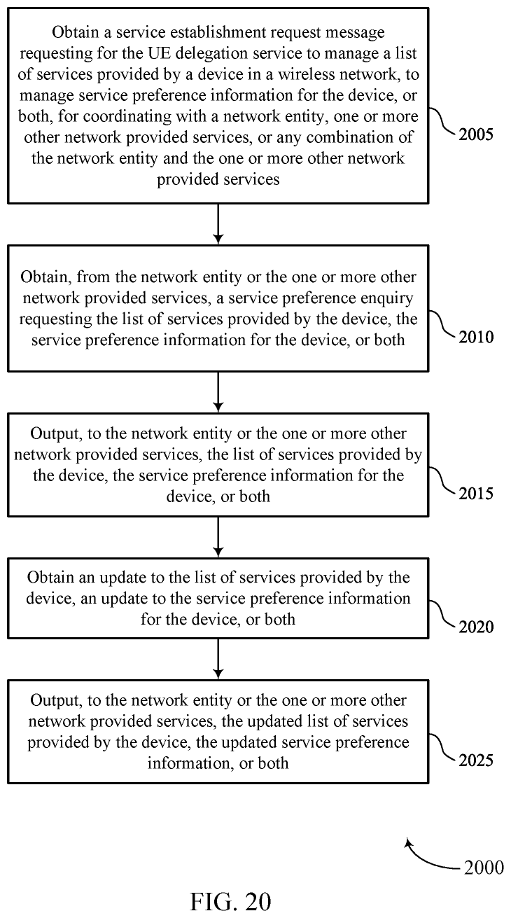

FIG. 20 shows a flowchart illustrating a method 2000 that supports registration of service preferences and capabilities in accordance with one or more aspects of the present disclosure. The operations of the method 2000 may be implemented by a network entity or its components as described herein. For example, the operations of the method 2000 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 2005, the method may include obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services. The operations of 2005 may be performed in accordance with examples as disclosed herein. In some examples, aspects of the operations of 2005 may be performed by a service establishment manager 1325 as described with reference to FIG. 13.

At 2010, the method may include obtaining a service preference enquiry requesting the list of services provided by the device, the service preference information for the device, or both. The operations of 2010 may be performed in accordance with examples as disclosed herein. In some examples, aspects of the operations of 2010 may be performed by a service preference enquiry manager 1330 as described with reference to FIG. 13.

At 2015, the method may include outputting, to the network entity or the one or more other network provided services, the list of services provided by the device, the service preference information for the device, or both. The operations of 2015 may be performed in accordance with examples as disclosed herein. In some examples, aspects of the operations of 2015 may be performed by a service information manager 1335 as described with reference to FIG. 13.

At 2020, the method may include obtaining an update to the list of services provided by the device, an update to the service preference information for the device, or both. The operations of 2020 may be performed in accordance with examples as disclosed herein. In some examples, aspects of the operations of 2020 may be performed by a service information manager 1335 as described with reference to FIG. 13.

At 2025, the method may include outputting, to the network entity or the one or more other network provided services, the updated list of services provided by the device, the updated service preference information, or both. The operations of 2025 may be performed in accordance with examples as disclosed herein. In some examples, aspects of the operations of 2025 may be performed by a service information manager 1335 as described with reference to FIG. 13.

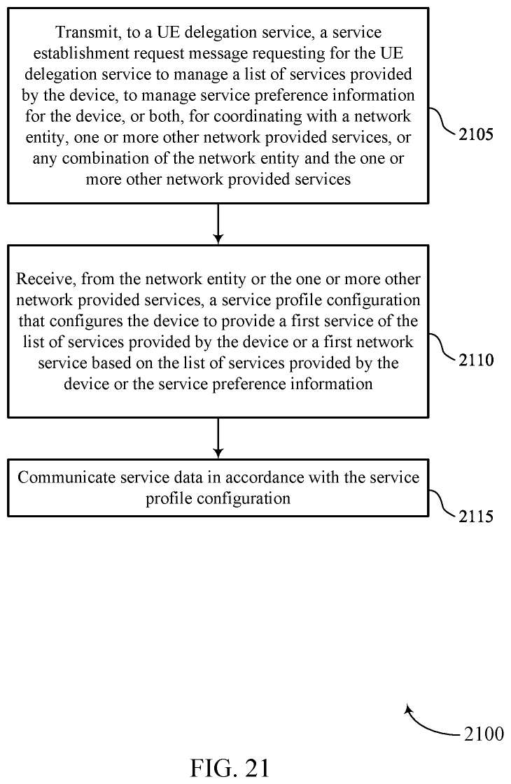

FIG. 21 shows a flowchart illustrating a method 2100 that supports registration of service preferences and capabilities in accordance with one or more aspects of the present disclosure. The operations of the method 2100 may be implemented by a UE or its components as described herein. For example, the operations of the method 2100 may be performed by a UE 115 as described with reference to FIGS. 1 through 9 and 15 through 18. In some examples, a UE may execute a set of instructions to control the functional elements of the UE to perform the described functions. Additionally, or alternatively, the UE may perform aspects of the described functions using special-purpose hardware.

At 2105, the method may include transmitting a service establishment request message requesting for the UE delegation service to manage a list of services provided by the device, to manage service preference information for the device, or both, for coordinating with a network entity, one or more other network provided services, or any combination of the network entity and the one or more other network provided services. The operations of 2105 may be performed in accordance with examples as disclosed herein. In some examples, aspects of the operations of 2105 may be performed by a service establishment component 1725 as described with reference to FIG. 17.

At 2110, the method may include receiving a service profile configuration that configures the device to provide a first service of the list of services provided by the device or a first network service based on the list of services provided by the device or the service preference information. The operations of 2110 may be performed in accordance with examples as disclosed herein. In some examples, aspects of the operations of 2110 may be performed by a service configuration component 1730 as described with reference to FIG. 17.

At 2115, the method may include communicating service data in accordance with the service profile configuration. The operations of 2115 may be performed in accordance with examples as disclosed herein. In some examples, aspects of the operations of 2115 may be performed by a service data component 1735 as described with reference to FIG. 17.

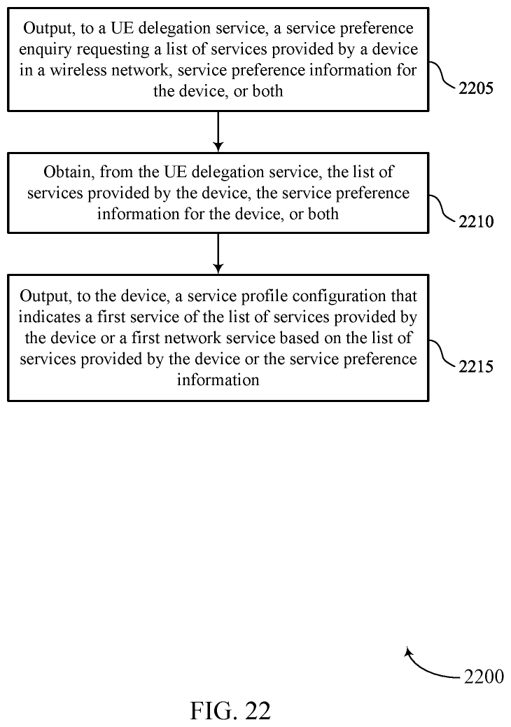

FIG. 22 shows a flowchart illustrating a method 2200 that supports registration of service preferences and capabilities in accordance with one or more aspects of the present disclosure. The operations of the method 2200 may be implemented by a network entity or its components as described herein. For example, the operations of the method 2200 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 2205, the method may include outputting a service preference enquiry requesting a list of services provided by a device in a wireless network, service preference information for the device, or both. The operations of 2205 may be performed in accordance with examples as disclosed herein. In some examples, aspects of the operations of 2205 may be performed by a service preference enquiry manager 1330 as described with reference to FIG. 13.

At 2210, the method may include obtaining the list of services provided by the device, the service preference information for the device, or both. The operations of 2210 may be performed in accordance with examples as disclosed herein. In some examples, aspects of the operations of 2210 may be performed by a service information manager 1335 as described with reference to FIG. 13.

At 2215, the method may include outputting, to the device, a service profile configuration that indicates a first service of the list of services provided by the device or a first network service based on the list of services provided by the device or the service preference information. The operations of 2215 may be performed in accordance with examples as disclosed herein. In some examples, aspects of the operations of 2215 may be performed by a service configuration manager 1340 as described with reference to FIG. 13.

The following provides an overview of aspects of the present disclosure:

Aspect 1: An apparatus for wireless communications at a UE delegation service, comprising one or more memories, and one or more processors coupled with the one or more memories and configured to cause the UE delegation service to: obtain a service establishment request message that requests for the UE delegation service to manage a list of services provided by a device in a wireless network, to manage service preference information for the device, or both, for coordinating with a network entity, one or more other network provided services, or any combination of the network entity and the one or more other network provided services; obtain, from the network entity or the one or more other network provided services, a service preference enquiry requesting the list of services provided by the device, the service preference information for the device, or both; and output, to the network entity or the one or more other network provided services, the list of services provided by the device, the service preference information for the device, or both.

Aspect 2: The apparatus of aspect 29, the one or more processors coupled with the one or more memories and configured to cause the UE delegation service to: obtain an update to the list of services provided by the device, an update to the service preference information for the device, or both; and output, to the network entity or the one or more other network provided services, the updated list of services provided by the device, the updated service preference information, or both.

Aspect 3: The apparatus of any of aspects 29 through 30, the one or more processors coupled with the one or more memories and configured to cause the UE delegation service to: obtain a subscription request indicating for the UE delegation service to output, to the network entity or the one or more other network provided services, one or more changes in the list of services provided by the device or the service preference information for the device.

Aspect 4: The apparatus of any of aspects 29 through 31, wherein the service preference information for the device comprises service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Aspect 5: The apparatus of any of aspects 29 through 32, the one or more processors coupled with the one or more memories and configured to cause the UE delegation service to: obtain, from a service consumer, a second service preference enquiry requesting the list of services provided by the device; and output, to the service consumer, the list of services provided by the device and one or more of an identity of the device, service ID information, and service profile information for the list of services provided by the device.

Aspect 6: The apparatus of any of aspects 29 through 33, wherein the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

Aspect 7: The apparatus of any of aspects 29 through 34, wherein the UE delegation service is implemented at a DSS, at the network entity, at a subscription service, or at the one or more other network provided services.

Aspect 8: The apparatus of any of aspects 29 through 35, wherein the service preference enquiry comprises one or more of an ID of the device, one or more service IDs of one or more services, or any combination thereof.

Aspect 9: The apparatus of any of aspects 29 through 36, wherein the device comprises an OAM entity, a SMO entity, or a UE.

Aspect 10: An apparatus for wireless communications by a device in a wireless network, comprising one or more memories, and one or more processors coupled with the one or more memories and configured to cause the device to: transmit a service establishment request message that requests for the UE delegation service to manage a list of services provided by the device, to manage service preference information for the device, or both, for coordinating with a network entity, one or more other network provided services, or any combination of the network entity and the one or more other network provided services; receive a service profile configuration that configures the device to provide a first service of the list of services provided by the device or a first network service based at least in part on the list of services provided by the device or the service preference information; and communicate service data in accordance with the service profile configuration.

Aspect 11: The apparatus of aspect 38, the one or more processors coupled configured to cause the device to: transmit, to the UE delegation service, an update to the list of services provided by the device, an update to the service preference information for the device, or both based at least in part on a change in the list of services provided by the device, a change in the service preference information for the device, a change in geographical location of the device, or any combination thereof.

Aspect 12: The apparatus of any of aspects 38 through 39, wherein the service preference information for the device comprises service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Aspect 13: The apparatus of any of aspects 38 through 40, wherein the service profile configuration comprises a service ID, service prioritization information, a periodicity associated with reporting information related to one or more services, an indication of one or more triggers for to report the information related to one or more services, or any combination thereof.

Aspect 14: The apparatus of any of aspects 38 through 41, the one or more processors coupled configured to cause the device to: receive an indication of service preference information for one or more other devices of the wireless network.

Aspect 15: The apparatus of any of aspects 38 through 42, wherein the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

Aspect 16: The apparatus of any of aspects 38 through 43, further comprising: transmitting, to the network entity or the one or more other network provided services, an acknowledgement message in response to the service profile configuration.

Aspect 17: The apparatus of any of aspects 38 through 44, wherein the device comprises an OAM entity, a SMO entity, or a UE.

Aspect 18: An apparatus for wireless communications by a network entity, comprising one or more memories, and one or more processors coupled with the one or more memories and configured to cause the network entity to: output a service preference enquiry that requests a list of services provided by a device in a wireless network, service preference information for the device, or both; obtain the list of services provided by the device, the service preference information for the device, or both; and output, to the device, a service profile configuration that indicates a first service of the list of services provided by the device or a first network service based at least in part on the list of services provided by the device or the service preference information.

Aspect 19: The apparatus of aspect 46, wherein the service preference enquiry comprises one or more of an ID of the device, one or more service IDs of one or more services, or any combination thereof.

Aspect 20: The apparatus of any of aspects 46 through 47, the one or more processors configured to cause the network entity to: output a subscription request that indicates for the UE delegation service to output, to the network entity, one or more changes in the list of services provided by the device or the service preference information for the device.

Aspect 21: The apparatus of any of aspects 46 through 48, wherein the service preference information for the device comprises service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Aspect 22: The apparatus of any of aspects 46 through 49, wherein the service profile configuration comprises a service ID, service prioritization information, a periodicity associated with reporting information related to one or more services, an indication of one or more triggers for to report the information related to one or more services, or any combination thereof.

Aspect 23: The apparatus of any of aspects 46 through 50, the one or more processors configured to cause the network entity to: obtain, from a second network entity, an ID of the device and a selection service ID that identifies the network entity as being a selection service for the device; select one or more services for the device based at least in part on the ID of the device and the selection service ID; and output, to the second network entity, an indication of one or more service IDs of the one or more services, one or more supported functions of the one or more services, routing information associated with the one or more services, or any combination thereof.

Aspect 24: The apparatus of any of aspects 46 through 51, the one or more processors configured to cause the network entity to: output, to a DSS, an ID of the device and a selection service ID that identifies the DSS as being a selection service for the device; and obtain, from the DSS, an indication of one or more service IDs of one or more services selected for the device, one or more supported functions of the one or more services, routing information associated with the one or more services, or any combination thereof.

Aspect 25: The apparatus of any of aspects 46 through 52, the one or more processors configured to cause the network entity to: output, to the device, an indication of service preference information for one or more additional devices in the wireless network.

Aspect 26: The apparatus of any of aspects 46 through 53, the one or more processors configured to cause the network entity to: obtain, from the device, an acknowledgement message in response to the service profile configuration.

Aspect 27: The apparatus of any of aspects 46 through 54, wherein the network entity comprises a DSS, a RAN entity, an access and mobility service, a topology management service, a subscription service, or one or more other network provided services.

Aspect 28: The apparatus of any of aspects 46 through 55, wherein the device comprises an OAM entity, a SMO entity, or a UE.

Aspect 29: A method for wireless communications by a UE delegation service, comprising: obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services; obtaining a service preference enquiry requesting the list of services provided by the device, the service preference information for the device, or both; and outputting, to the network entity or the one or more other network provided services, the list of services provided by the device, the service preference information for the device, or both.

Aspect 30: The method of aspect 29, further comprising: obtaining an update to the list of services provided by the device, an update to the service preference information for the device, or both; and outputting, to the network entity or the one or more other network provided services, the updated list of services provided by the device, the updated service preference information, or both.

Aspect 31: The method of any of aspects 29 through 30, further comprising: obtaining a subscription request indicating for the UE delegation service to output, to the network entity or the one or more other network provided services, one or more changes in the list of services provided by the device or the service preference information for the device.

Aspect 32: The method of any of aspects 29 through 31, wherein the service preference information for the device comprises service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Aspect 33: The method of any of aspects 29 through 32, further comprising: obtaining, from a service consumer, a second service preference enquiry requesting the list of services provided by the device; and outputting, to the service consumer, the list of services provided by the device and one or more of an identity of the device, service ID information, and service profile information for the list of services provided by the device.

Aspect 34: The method of any of aspects 29 through 33, wherein the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

Aspect 35: The method of any of aspects 29 through 34, wherein the UE delegation service is implemented at a DSS, at the network entity, at a subscription service, or at the one or more other network provided services.

Aspect 36: The method of any of aspects 29 through 35, wherein the service preference enquiry comprises one or more of an ID of the device, one or more service IDs of one or more services, or any combination thereof.

Aspect 37: The method of any of aspects 29 through 36, wherein the device comprises an OAM entity, a SMO entity, or a UE.

Aspect 38: A method for wireless communications by a device in a wireless network, comprising: transmitting a service establishment request message requesting for the UE delegation service to manage a list of services provided by the device, to manage service preference information for the device, or both, for coordinating with a network entity, one or more other network provided services, or any combination of the network entity and the one or more other network provided services; receiving a service profile configuration that configures the device to provide a first service of the list of services provided by the device or a first network service based at least in part on the list of services provided by the device or the service preference information; and communicating service data in accordance with the service profile configuration.

Aspect 39: The method of aspect 38, further comprising: transmitting, to the UE delegation service, an update to the list of services provided by the device, an update to the service preference information for the device, or both based at least in part on a change in the list of services provided by the device, a change in the service preference information for the device, a change in geographical location of the device, or any combination thereof.

Aspect 40: The method of any of aspects 38 through 39, wherein the service preference information for the device comprises service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Aspect 41: The method of any of aspects 38 through 40, wherein the service profile configuration comprises a service ID, service prioritization information, a periodicity associated with reporting information related to one or more services, an indication of one or more triggers for reporting the information related to one or more services, or any combination thereof.

Aspect 42: The method of any of aspects 38 through 41, further comprising: receiving an indication of service preference information for one or more other devices of the wireless network.

Aspect 43: The method of any of aspects 38 through 42, wherein the service establishment request message requests to register the device with the UE delegation service and indicates one or more of an ID of the device, service configuration preference information, prioritization information for the list of services provided by the device, measurement gap preferences, RAT preferences, network type preferences, service instance applicability information that indicates one or more conditions for configuring a service instance, or any combination thereof.

Aspect 44: The method of any of aspects 38 through 43, further comprising: transmitting, to the network entity or the one or more other network provided services, an acknowledgement message in response to the service profile configuration.

Aspect 45: The method of any of aspects 38 through 44, wherein the device comprises an OAM entity, a SMO entity, or a UE.

Aspect 46: A method for wireless communications by a network entity, comprising: outputting a service preference enquiry requesting a list of services provided by a device in a wireless network, service preference information for the device, or both; obtaining the list of services provided by the device, the service preference information for the device, or both; and outputting, to the device, a service profile configuration that indicates a first service of the list of services provided by the device or a first network service based at least in part on the list of services provided by the device or the service preference information.

Aspect 47: The method of aspect 46, wherein the service preference enquiry comprises one or more of an ID of the device, one or more service IDs of one or more services, or any combination thereof.

Aspect 48: The method of any of aspects 46 through 47, further comprising: outputting a subscription request indicating for the UE delegation service to output, to the network entity, one or more changes in the list of services provided by the device or the service preference information for the device.

Aspect 49: The method of any of aspects 46 through 48, wherein the service preference information for the device comprises service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

Aspect 50: The method of any of aspects 46 through 49, wherein the service profile configuration comprises a service ID, service prioritization information, a periodicity associated with reporting information related to one or more services, an indication of one or more triggers for reporting the information related to one or more services, or any combination thereof.

Aspect 51: The method of any of aspects 46 through 50, further comprising: obtaining, from a second network entity, an ID of the device and a selection service ID that identifies the network entity as being a selection service for the device; selecting one or more services for the device based at least in part on the ID of the device and the selection service ID; and outputting, to the second network entity, an indication of one or more service IDs of the one or more services, one or more supported functions of the one or more services, routing information associated with the one or more services, or any combination thereof.

Aspect 52: The method of any of aspects 46 through 51, further comprising: outputting, to a DSS, an ID of the device and a selection service ID that identifies the DSS as being a selection service for the device; and obtaining, from the DSS, an indication of one or more service IDs of one or more services selected for the device, one or more supported functions of the one or more services, routing information associated with the one or more services, or any combination thereof.

Aspect 53: The method of any of aspects 46 through 52, further comprising:

outputting, to the device, an indication of service preference information for one or more additional devices in the wireless network.

Aspect 54: The method of any of aspects 46 through 53, further comprising: obtaining, from the device, an acknowledgement message in response to the service profile configuration.

Aspect 55: The method of any of aspects 46 through 54, wherein the network entity comprises a DSS, a RAN entity, an access and mobility service, a topology management service, a subscription service, or one or more other network provided services.

Aspect 56: The method of any of aspects 46 through 55, wherein the device comprises an OAM entity, a SMO entity, or a UE.

Aspect 57: A UE delegation service for wireless communications, comprising at least one means for performing a method of any of aspects 29 through 37.

Aspect 58: A non-transitory computer-readable medium storing code for wireless communications, the code comprising instructions executable by one or more processors to perform a method of any of aspects 29 through 37.

Aspect 59: A UE delegation service, comprising: a processing system that includes processor circuitry and memory circuitry that stores code and is coupled with the processor circuitry, the processing system configured to cause the UE delegation service to perform a method of any of aspects 29 through 37.

Aspect 60: A device in a wireless network for wireless communications, comprising at least one means for performing a method of any of aspects 38 through 45.

Aspect 61: A non-transitory computer-readable medium storing code for wireless communications, the code comprising instructions executable by one or more processors to perform a method of any of aspects 38 through 45.

Aspect 62: A device in a wireless network, comprising: a processing system that includes processor circuitry and memory circuitry that stores code and is coupled with the processor circuitry, the processing system configured to cause the device to perform a method of any of aspects 38 through 45.

Aspect 63: A network entity for wireless communications, comprising at least one means for performing a method of any of aspects 46 through 56.

Aspect 64: A non-transitory computer-readable medium storing code for wireless communications, the code comprising instructions executable by one or more processors to perform a method of any of aspects 46 through 56.

Aspect 65: A network entity, comprising: a processing system that includes processor circuitry and memory circuitry that stores code and is coupled with the processor circuitry, the processing system configured to cause the network entity to perform a method of any of aspects 46 through 56.

Aspect 66: A UE delegation service, comprising: a processing system that includes processor circuitry and memory circuitry that stores code and is coupled with the processor circuitry, the processing system configured to cause the UE delegation service to: obtain a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services; obtain, from the network entity or the one or more other network provided services, a service preference enquiry requesting the list of services provided by the device, the service preference information for the device, or both; and output, to the network entity or the one or more other network provided services, the list of services provided by the device, the service preference information for the device, or both.

Aspect 67: A device in a wireless network, comprising: a processing system that includes processor circuitry and memory circuitry that stores code and is coupled with the processor circuitry, the processing system configured to cause the device to transmit, to a UE delegation service, a service establishment request message requesting for the UE delegation service to manage a list of services provided by the device, to manage service preference information for the device, or both, for coordinating with a network entity, one or more other network provided services, or any combination of the network entity and the one or more other network provided services; receive, from the network entity or the one or more other network provided services, a service profile configuration that configures the device to provide a first service of the list of services provided by the device or a first network service based at least in part on the list of services provided by the device or the service preference information; and communicate service data in accordance with the service profile configuration.

Aspect 68: A network entity, comprising: a processing system that includes processor circuitry and memory circuitry that stores code and is coupled with the processor circuitry, the processing system configured to cause the network entity to: output, to a UE delegation service, a service preference enquiry requesting a list of services provided by a device in a wireless network, service preference information for the device, or both; obtain, from the UE delegation service, the list of services provided by the device, the service preference information for the device, or both; and output, to the device, a service profile configuration that indicates a first service of the list of services provided by the device or a first network service based at least in part on the list of services provided by the device or the service preference information

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication by a user equipment (UE) delegation service, comprising:
one or more memories; and
one or more processors coupled with the one or more memories and configured to cause the UE delegation service to:
obtain a service establishment request message that requests for the UE delegation service to manage a list of services provided by a device in a wireless network, to manage service preference information for the device, or both, for coordination with a network entity, one or more other network provided services, or any combination of the network entity and the one or more other network provided services;
obtain, from the network entity or the one or more other network provided services, a service preference enquiry that requests the list of services provided by the device, the service preference information for the device, or both; and
output, to the network entity or the one or more other network provided services, the list of services provided by the device, the service preference information for the device, or both.

2. The apparatus of claim 1, wherein the one or more processors are further configured to cause the UE delegation service to:
obtain an update to the list of services provided by the device, an update to the service preference information for the device, or both; and
output, to the network entity or the one or more other network provided services, the updated list of services provided by the device, the updated service preference information, or both.

3. The apparatus of claim 1, wherein the one or more processors are further configured to cause the UE delegation service to:
obtain a subscription request indicating for the UE delegation service to output, to the network entity or the one or more other network provided services, one or more changes in the list of services provided by the device or the service preference information for the device.

4. The apparatus of claim 1, the service preference information for the device comprising service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

5. The apparatus of claim 1, wherein the one or more processors are further configured to cause the UE delegation service to:
obtain, from a service consumer, a second service preference enquiry requesting the list of services provided by the device; and
output, to the service consumer, the list of services provided by the device and one or more of an identity of the device, service identifier information, and service profile information for the list of services provided by the device.

6. The apparatus of claim 1, wherein the service establishment request message comprises a request to register the device with the UE delegation service and an indication of one or more of an identifier of the device, service configuration preference information, prioritization information for the list of services provided by the device, measurement gap preferences, radio access technology (RAT) preferences, network type preferences, service instance applicability information that indicates one or more conditions for configuration of a service instance, or any combination thereof.

7. The apparatus of claim 1, wherein the UE delegation service is implemented at a discovery and selection service, at the network entity, at a subscription service, or at the one or more other network provided services.

8. The apparatus of claim 1, wherein the service preference enquiry comprises one or more of an identifier of the device, one or more service identifiers of one or more services, or any combination thereof.

9. The apparatus of claim 1, the device comprising an operations and management entity, a service management and orchestration entity, or a UE.

10. An apparatus for wireless communication at a device in a wireless network, comprising:
one or more memories; and
one or more processors coupled with the one or more memories and configured to cause the device to:
transmit a service establishment request message that requests for a user equipment (UE) delegation service to manage a list of services provided by the device, to manage service preference information for the device, or both, for coordinating with a network entity, one or more other network provided services, or any combination of the network entity and the one or more other network provided services;
receive a service profile configuration that configures the device to provide a first service of the list of services provided by the device or a first network service based at least in part on the list of services provided by the device or the service preference information; and
communicate service data in accordance with the service profile configuration.

11. The apparatus of claim 10, wherein the one or more processors are configured to cause the device to:
transmit, to the UE delegation service, an update to the list of services provided by the device, an update to the service preference information for the device, or both based at least in part on a change in the list of services provided by the device, a change in the service preference information for the device, a change in geographical location of the device, or any combination thereof.

12. The apparatus of claim 10, the service preference information for the device comprising service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

13. The apparatus of claim 10, the service profile configuration comprising a service identifier, service prioritization information, a periodicity associated with reporting information related to one or more services, an indication of one or more triggers for reporting the information related to one or more services, or any combination thereof.

14. The apparatus of claim 10, wherein the one or more processors are configured to cause the device to:
receive, from the network entity or the one or more other network provided services, an indication of service preference information for one or more other devices of the wireless network.

15. The apparatus of claim 10, the service establishment request message comprising a request to register the device with the UE delegation service and comprising an indication of one or more of an identifier of the device, service configuration preference information, prioritization information for the list of services provided by the device, measurement gap preferences, radio access technology (RAT) preferences, network type preferences, service instance applicability information that indicates one or more conditions for configuring a service instance, or any combination thereof.

16. The apparatus of claim 10, wherein the one or more processors are configured to cause the device to:
transmit, to the network entity or the one or more other network provided services, an acknowledgement message in response to the service profile configuration.

17. The apparatus of claim 10, the device comprising an operations and management entity, a service management and orchestration entity, or a UE.

18. An apparatus for wireless communication at a network entity, comprising:
one or more memories; and
one or more processors coupled with the one or more memories and configured to cause the network entity to:
output a service preference enquiry that requests a list of services provided by a device in a wireless network, service preference information for the device, or both;
obtain the list of services provided by the device, the service preference information for the device, or both; and
output a service profile configuration that indicates a first service of the list of services provided by the device or a first network service based at least in part on the list of services provided by the device or the service preference information.

19. The apparatus of claim 18, the service preference enquiry comprising one or more of an identifier of the device, one or more service identifiers of one or more services, or any combination thereof.

20. The apparatus of claim 18, wherein the one or more processors are configured to cause the network entity to:
output a subscription request that indicates for a user equipment (UE) delegation service to output, to the network entity, one or more changes in the list of services provided by the device or the service preference information for the device.

21. The apparatus of claim 18, the service preference information for the device comprising service preference information for one or more features supported by the device, for one or more feature groups supported by the device, for one or more functionalities supported by the device, for one or more codebook indexes used at the network entity, for one or more antenna patterns used at the network entity, for one or more beams configured for the device or used at the network entity, for one or more operating modes used at the network entity, for one or more geographical areas, or any combination thereof.

22. The apparatus of claim 18, the service profile configuration comprising a service identifier, service prioritization information, a periodicity associated with reporting information related to one or more services, an indication of one or more triggers to report the information related to one or more services, or any combination thereof.

23. The apparatus of claim 18, wherein the one or more processors are configured to cause the network entity to:
obtain, from a second network entity, an identifier of the device and a selection service identifier that identifies the network entity as being a selection service for the device;
select one or more services for the device based at least in part on the identifier of the device and the selection service identifier; and
output, to the second network entity, an indication of one or more service identifiers of the one or more services, one or more supported functions of the one or more services, routing information associated with the one or more services, or any combination thereof.

24. The apparatus of claim 18, wherein the one or more processors are configured to cause the network entity to:
output, to a discovery and selection service, an identifier of the device and a selection service identifier that identifies the discovery and selection service as being a selection service for the device; and
obtain, from the discovery and selection service, an indication of one or more service identifiers of one or more services selected for the device, one or more supported functions of the one or more services, routing information associated with the one or more services, or any combination thereof.

25. The apparatus of claim 18, wherein the one or more processors are configured to cause the network entity to:
output, to the device, an indication of service preference information for one or more additional devices in the wireless network.

26. The apparatus of claim 18, wherein the one or more processors are configured to cause the network entity to:
obtain, from the device, an acknowledgement message in response to the service profile configuration.

27. The apparatus of claim 18, the network entity comprising a discovery and selection service, a radio access network entity, an access and mobility service, a topology management service, a subscription service, or one or more other network provided services.

28. The apparatus of claim 18, the device comprising an operations and management entity, a service management and orchestration entity, or a user equipment (UE).

29. A method for wireless communications by a user equipment (UE) delegation service, comprising:
obtaining a service establishment request message requesting for the UE delegation service to manage a list of services provided by a device in a wireless network, to manage service preference information for the device, or both, for coordinating with a network entity, one or more other network provided services, or any combination of the network entity and the one or more other network provided services;
obtaining, from the network entity or the one or more other network provided services, a service preference enquiry requesting the list of services provided by the device, the service preference information for the device, or both; and
outputting, to the network entity or the one or more other network provided services, the list of services provided by the device, the service preference information for the device, or both.

30. The method of claim 29, further comprising:
obtaining an update to the list of services provided by the device, an update to the service preference information for the device, or both; and
outputting, to the network entity or the one or more other network provided services, the updated list of services provided by the device, the updated service preference information, or both.
